(19) United States
(12) Patent Application Publication
(10) Pub. No.: US 2026/0322601 A1
(43) Pub. Date: Oct. 15, 2026

(54) METHOD FOR BACKING UP AND RESTORING A SECRET HELD BY A CRYPTOASSET WALLET

(71) Applicant: LEDGER, Paris (FR)

(72) Inventors: Laurent CASTILLO, Suresnes (FR); Andrianina Sandra RASOAMIARAMANANA, Bures-sur-Yvette (FR); Daniel ROCHA FURTADO, Noisy-le-Grand (FR)

(21) Appl. No.: 19/141,984

(22) PCT Filed: Dec. 22, 2023
(86) PCT No.: PCT/FR2023/000195

§ 371 Date: Jun. 20, 2025

(30) Foreign Application Priority Data
Dec. 23, 2022 (FR) FR2214386
Dec. 23, 2022 (FR) FR2214387
Dec. 23, 2022 (FR) FR2214391

(51) Int. Cl. H04L 9/08; G06F 11/1446; H04L 9/32

(52) U.S. Cl. CPC H04L 9/0894; G06F 11/1469; H04L 9/0819; H04L 9/085; H04L 9/3268; G06F 2201/805

(57) ABSTRACT

A method for backing up and restoring a secret held by a cryptoasset wallet, comprising, for backing up the secret, the steps of providing a plurality of backup servers, collecting information relating to the user's identity, communicating to each backup server the information relating to the user's identity, by means of the cryptoasset wallet, generating a plurality of secret data from the secret, and transferring to each backup server one of the secret data provided by the cryptoasset wallet, in an encrypted form, and associating the secret data with the user's identity in the backup server.

### CROSS-REFERENCE TO RELATED APPLICATIONS

This application is a 371 National Stage of International Application No. PCT/FR2023/000195 filed Dec. 22, 2023, which claims priority to French Patent Application Nos. FR2214386, FR2214387, FR2214391, all filed Dec. 23, 2022, the disclosures of which are herein incorporated by reference in their entirety.

### TECHNICAL FIELD

The present disclosure relates to a method for backing up and restoring a secret held by an electronic device, and a method for securing the backup and restoration of a secret held by an electronic device. The present disclosure also relates to securing a secure data connection between an electronic device and a server. The present disclosure particularly relates to hierarchical deterministic hardware wallets used for storing private keys for managing accounts on the blockchain.

### BACKGROUND

In recent years, the development of cryptocurrencies or other types of blockchain-managed cryptoassets, such as non-fungible tokens (“NFTs”) and smart contracts, has given rise to various means of storing and safekeeping private and public keys attached to these different types of cryptoassets. This has led to the emergence of cryptoasset wallets that enable the storage and safekeeping of these keys. A cryptoasset wallet is a hardware or software device whose function is to store private and public keys attached to cryptoasset accounts, and to sign transactions using these keys. A distinction is made between “hot wallets” and “cold wallets”. “Hot wallets” are connected to the Internet and susceptible to hacker attacks or exposure to viruses and malware. These can be wallets managed by centralized exchange platforms or programs installed on mobile phones, tablets, or personal computers (“software wallets”). Such wallets are connected to the Internet and therefore themselves susceptible to attacks. “Cold wallets” or hardware wallets are, on the other hand, devoid of any direct access to the Internet, which reduces the attack surface and thus the risk of theft by hacking. A hardware wallet is generally a portable electronic device, equipped with a processor having cryptographic calculation capabilities. Transactions involving private keys are signed in an offline environment. Any online transaction is temporarily transferred to the hardware wallet to be digitally signed offline, before the signature is transmitted to the online network. As private keys are not communicated to online servers during the signing process, a hacker cannot access them.

Such a type of hardware wallet is therefore considered today as the safest solution against hacker attacks. Its only disadvantage lies in the risk of loss, theft, or destruction (fire for example) of the hardware wallet, or loss of the user's personal passphrase allowing its use. The keys it contains should therefore generally be backed up in a safe place.

A first problem that arose in the past was finding a way to simplify the number of keys to be backed up, which could be very numerous if the user has many cryptoasset accounts on the blockchain. To solve this problem, a hierarchical deterministic wallet was proposed by Bitcoin. First proposed in the BIP32 standard, then optimized with the BIP39, BIP43, and BIP44 standards, it allows users to avoid making a new backup for each new key pair generated, as a single backup for all the keys in their wallet is sufficient. This solution is now used by the vast majority of software or hardware cryptoasset wallets.

With a hierarchical deterministic wallet, all of the user's private keys are generated from an original random seed or “master key”. A user only needs to keep the seed in a safe place to recover all their keys, which are derived from the seed and can be reconstructed from it (“child keys”).

To facilitate memorization and storage of the seed, the BIP39 standard also provides for expressing the seed, which is a long binary number, in the form of a mnemonic phrase also called a “recovery phrase”. The exact type of BIP39 seed currently used in the applicant's devices is a recovery phrase that consists of 24 words chosen from a list of 2048 words defined by the aforementioned standard.

For the generation of a recovery phrase, a hardware wallet generates a sequence of 256 random bits using a random number generator. The first 8 bits of a SHA-256 hash of the initial 256 bits are added to this bit string, providing 264 bits. The 264 bits are divided into 24 groups of 11 bits by the device. Each group of 11 bits is interpreted as a number between 0 and 2047, which serves as an index to the BIP39 word list, resulting in the 24-word mnemonic phrase. This type of wallet therefore requires only a single backup of the seed, preferably at the time of its commissioning, from which it is possible to derive the entire descending tree of keys.

FIG. 1 schematically shows a cryptoasset wallet comprising a hardware wallet HW, for example the device marketed by the applicant under the name “Nano” or “Stax”, and a host device HDV executing a companion application HSW, for example the “Ledger Live” application developed by the applicant. Since the device HW cannot connect directly to the Internet, it is associated with the host device HDV to perform transactions on the blockchain. The host device HDV is, for example, a computer, mobile phone, tablet, or equivalent. The connection between the device HW and the host device HDV can be through USB or Bluetooth, for example.

Once connected to the host device, the device HW can interact with the companion software to allow a user USR to perform transactions on the blockchain BCN or on decentralized exchange sites. The device HW can also communicate with a Hardware Security Module HSM located in a datacenter. The HSM module is conventionally a hardware encryption device allowing the generation, storage, and protection of cryptographic keys. The HSM module does not store any private keys of the user and only ensures control of the authenticity of the device HW, its commissioning, the update of its operating system, the download of certified application programs, etc.

When the device HW is first commissioned, it provides the user with a 24-word recovery phrase that they will have to keep on an appropriate physical medium, for example a sheet of paper or an unalterable medium such as an engraved metal plate, which they will store in a safe place.

Such safekeeping of the recovery phrase in a secure location is not without problems. Indeed, if a third party gets hold of the recovery phrase, the third party will be able to access all of the user's cryptoasset accounts generated from the seed and transfer the sums they contain to other accounts, and it will then be very difficult to identify them.

The document “Cryptocurrency wallet-Wikipedia” of Nov. 2, 2018 (2018-11-02), XP055664110 highlights the difference between a cryptocurrency hardware wallet and a software wallet, as just recalled. This document reminds that hardware wallets are considered secure because private keys never leave the physical wallet. If a hardware wallet uses a mnemonic phrase for backup, users should not store the mnemonic phrase electronically, but write it down and store it in a separate physical location, since electronic storage of the backup lowers the security level to that of a software wallet.

It would therefore be desirable to provide users with a simple and practical way to safekeep their recovery phrase in a highly secure manner.

Document US2022166605A1 discloses a method of dividing a cryptographic key into multiple fragments, in order to enhance the security of a cryptocurrency transaction signature performed by a computing platform using this cryptographic key. The division of the cryptographic key prevents any single entity or single device from having access to the complete key, thereby reducing the risks of fraud, collusion, or unauthorized access, by requiring that a certain number of fragments (quorum) be brought together to reconstruct the cryptographic key when signing a transaction. The key fragments are encrypted with Share Encryption Keys (SEKs) which are assigned to end user devices (EUDs) that use them to decrypt the SEKs. The SEKs, once decrypted, then allow the computing platform to decrypt the cryptographic key fragments. Operator keys are provided to encrypt and decrypt the SEKs. The operator keys are assigned to the EUDs, which use them to decrypt the SEKs. The SEKs, once decrypted, allow the computing platform to decrypt the cryptographic key fragments. The operator keys thus provide an additional layer of security by limiting access to the SEKs to only authorized EUDs.

### SUMMARY

Embodiments concern a method for backing up and restoring a secret held by a cryptoasset wallet, the method comprising, for backing up the secret, the steps consisting of providing a plurality of backup servers; collecting information relating to the user's identity; communicating to each backup server the information relating to the user's identity; by means of the cryptoasset wallet, generating a plurality of secret data from the secret, and transferring to each backup server one of the secret data provided by the cryptoasset wallet, in an encrypted form, and associating the secret data with the user's identity in the backup server.

According to an embodiment, each encrypted data is encrypted using an encryption key that is known only by the cryptoasset wallet and the backup server to which it is intended.

According to an embodiment, the information relating to the user's identity includes at least the user's first name, last name, and date of birth.

According to an embodiment, the cryptoasset wallet is configured to generate a plurality of secret data by means of a secret sharing function designed to generate a number m of secret data from the secret and allow the reconstruction of the secret from a threshold of n secret data.

According to an embodiment, the cryptoasset wallet comprises a hardware wallet devoid of means of connection to the Internet connected or configured to be connected to a host device executing companion software and provided with an Internet connection.

According to an embodiment, the method comprises, for the restoration of the secret, the following steps: communication to each backup server of the information relating to the user's identity, reception by the cryptoasset wallet, in an encrypted form, of all or part of the secret data held by the backup servers, and reconstruction of the secret by the cryptoasset wallet from the secret data provided by the backup servers and after decryption thereof.

According to an embodiment, the method comprises the steps consisting of providing an orchestrator program executed by a server, and configuring the orchestrator program and the cryptoasset wallet to execute at least one of the following steps: during the backup of the secret, transfer to the orchestrator program by the cryptoasset wallet of the secret data generated by the cryptoasset wallet, and transfer to the backup servers, by the orchestrator program of the secret data received from the cryptoasset wallet; during the restoration of the secret, reception by the orchestrator program of all or part of the secret data held by the backup servers, and transfer of these secret data to the cryptoasset wallet by the orchestrator program.

According to an embodiment, the method comprises the steps consisting of: establishing a first secure communication channel between the cryptoasset wallet and the orchestrator program, by means of a first session key generated after a key exchange between the cryptoasset wallet and the orchestrator program, and establishing a second secure communication channel between the cryptoasset wallet and each backup server through the orchestrator program, by means of a plurality of second session keys generated after a key exchange between the cryptoasset wallet and each backup server through the orchestrator program.

According to an embodiment, the orchestrator program, the cryptoasset wallet each possess a private key, a public key, a certificate signed by a certification authority, and a public key provided by the certification authority and the method comprises the following steps: the orchestrator program transfers its certificate to the cryptoasset wallet, the cryptoasset wallet transfers its certificate to the orchestrator program, the orchestrator program generates an ephemeral private key, an ephemeral public key and an ephemeral certificate signed with its private key, and transfers its ephemeral certificate to the cryptoasset wallet, the cryptoasset wallet generates an ephemeral private key, an ephemeral public key and an ephemeral certificate signed with its private key, and transfers its ephemeral certificate to the orchestrator program, the cryptoasset wallet generates the first session key from its ephemeral private key and the ephemeral public key of the orchestrator program, and the orchestrator program generates the first session key from its ephemeral private key and the ephemeral public key of the cryptoasset wallet.

According to an embodiment, before transferring its ephemeral certificate to the orchestrator program, the cryptoasset wallet generates a first signature of its ephemeral public key from its private key, the cryptoasset wallet encrypts the first signature by means of the first session key, to obtain an encrypted signature, the cryptoasset wallet transfers to the orchestrator an ephemeral certificate comprising its ephemeral public key and the encrypted signature, then the orchestrator program generates the first session key from its ephemeral private key and the ephemeral public key of the cryptoasset wallet, and by means of the first session key, the orchestrator program decrypts the signature present in the ephemeral certificate.

According to an embodiment, before generating the first signature of its ephemeral public key from its private key, the cryptoasset wallet concatenates its ephemeral public key with a data.

According to an embodiment, the method comprises the following steps: the cryptoasset wallet encrypts its certificate with the first session key before transferring it to the orchestrator program, and by means of the first session key, the orchestrator program decrypts the certificate of the cryptoasset wallet.

According to an embodiment, the backup servers each possess a private key, a public key, a certificate signed by a certification authority, and a public key provided by the certification authority, the orchestrator program transfers the certificate of the cryptoasset wallet and the ephemeral certificate of the cryptoasset wallet to each of the backup servers, each backup server transfers its certificate to the orchestrator program, which transfers it to the cryptoasset wallet, each backup server generates an ephemeral private key, an ephemeral public key and an ephemeral certificate signed with its private key, and transfers the ephemeral certificate to the orchestrator program which transfers it to the cryptoasset wallet, each backup server generates the second session key from its ephemeral private key and the ephemeral public key of the cryptoasset wallet, and the cryptoasset wallet generates the second session key of each backup server from its ephemeral private key and the ephemeral public key of the backup server.

According to an embodiment, the method comprises the following steps: for each backup server, the cryptoasset wallet encrypts the secret data intended for the backup server with the second session key, transfers the encrypted secret data to the orchestrator program which transfers it to the backup server, and each backup server decrypts the secret data received by means of the second session key, and stores it in a memory.

According to an embodiment, the cryptoasset wallet verifies the validity of the certificate of the orchestrator program by means of the public key of the certification authority, the cryptoasset wallet verifies the validity of the ephemeral certificate of the orchestrator program by means of the public key of the certificate of the orchestrator program, the cryptoasset wallet verifies the validity of the certificate of each backup server by means of the public key of the certification authority, the cryptoasset wallet verifies the validity of the ephemeral certificate of each backup server by means of the public key of the certificate of each backup server, the orchestrator program verifies the validity of the certificate of the cryptoasset wallet by means of the public key of the certification authority, the orchestrator program verifies the validity of the ephemeral certificate of the cryptoasset wallet by means of the public key of the certificate of the cryptoasset wallet, each backup server verifies the validity of the certificate of the cryptoasset wallet by means of the public key of the certification authority, and each backup server verifies the validity of the ephemeral certificate of the cryptoasset wallet by means of the public key of the certificate of the cryptoasset wallet.

According to an embodiment, data transmitted to the orchestrator program by a backup server are retransmitted by the orchestrator program to the cryptoasset wallet in a form encrypted by means of the first session key, and some of these data are previously hashed by the backup server by means of a hash function, then encrypted by means of the second session key.

According to an embodiment, before providing the secret data it holds, at least one backup server subjects the user to an identity verification step, and refuses to return the secret data if the verification of the user's identity is not conclusive.

Embodiments also concern a cryptoasset wallet holding or intended to hold a secret, configured to offer a user the following options: manually back up the secret in the form of a recovery phrase that will have to be kept by the user, or back up the secret in a plurality of backup servers, and, if the user chooses to back up the secret in a plurality of backup servers, conduct a step of collecting information relating to the user's identity, in the presence of the user, and a step of communicating to each backup server the information relating to the user's identity, generate a plurality of secret data from the secret, and transfer the secret data to the plurality of backup servers, in an encrypted form.

According to an embodiment, the cryptoasset wallet is configured to also offer the user the following options: manually restore the secret from a recovery phrase, or restore the secret from a plurality of backup servers, and, if the user chooses to restore the secret from a plurality of secret data held by a plurality of backup servers, reconstruct the secret from the data provided by the backup servers.

According to an embodiment, the cryptoasset wallet is configured to generate a plurality of secret data from the secret by means of a secret sharing function designed to generate a number m of secret data and allow the reconstruction of the secret from a threshold of n secret data.

According to an embodiment, the cryptoasset wallet is configured to transfer the secret data to the plurality of backup servers through an orchestrator program executed by a server, and recover each of the data provided by the backup servers through the orchestrator program.

According to an embodiment, the cryptoasset wallet is configured to, if the user chooses to restore the secret from the secret data, conduct at least one step of verification of the user's identity at the request of a backup server.

According to an embodiment, the cryptoasset wallet comprises a hardware wallet devoid of means of connection to the Internet, and a host device executing companion software and provided with an Internet connection, the companion software complementing the hardware wallet for the realization of steps requiring interaction with the user, notably steps of collecting information relating to the user's identity.

According to an embodiment, the hardware wallet comprises a touchscreen with a diagonal greater than or equal to 3.5 inches and exclusively controlled by a secure element, used notably to collect information relating to the user's identity.

### BRIEF DESCRIPTION OF THE DRAWINGS

These features as well as others of the present disclosure will be better understood upon reading the following non-limiting description in relation to the attached figures among which:

FIG. 1, previously described, schematically shows a cryptoasset wallet and an example of its use,

FIG. 2A and FIG. 2B show a cryptoasset wallet according to the disclosure and the architecture of a system provided for implementing a first embodiment of the method according to the disclosure, FIG. 2A illustrating a data backup step and FIG. 2B a data restoration step,

FIG. 3A and FIG. 3B show a cryptoasset wallet according to the disclosure and the architecture of a system provided for implementing a second embodiment of the method according to the disclosure, FIG. 3A illustrating a data backup step and FIG. 3B a data restoration step,

FIG. 4A describes an algorithm executed by the system of FIGS. 3A, 3B, during the data backup step,

FIG. 4B is a sequence diagram that represents the steps of the algorithm of FIG. 4A in the form of interactions between different elements of the system of FIGS. 3A, 3B,

FIG. 5A describes an algorithm executed by the system of FIGS. 3A, 3B, during the data restoration step,

FIG. 5B is a sequence diagram that represents the steps of the algorithm of FIG. 5A in the form of interactions between different elements of the system of FIGS. 3A, 3B,

FIG. 6A and FIG. 6B show a cryptoasset wallet according to the disclosure and the architecture of a system provided for implementing a third embodiment of the method according to the disclosure, FIG. 6A illustrating a data backup step and FIG. 6B a data restoration step,

FIG. 7 shows a cryptoasset wallet according to the disclosure and an example of hardware wallet architecture according to the disclosure allowing the implementation of the method according to the disclosure,

FIG. 8 shows steps conducted by the user of the hardware wallet of FIG. 7 for backing up the seed stored in the hardware wallet,

FIG. 9 shows steps conducted by the user of the hardware wallet of FIG. 7 for restoring the seed,

FIG. 10 shows another embodiment of a cryptoasset wallet allowing the implementation of the method according to the disclosure,

FIG. 11 shows yet another embodiment of a cryptoasset wallet allowing the implementation of the method according to the disclosure.

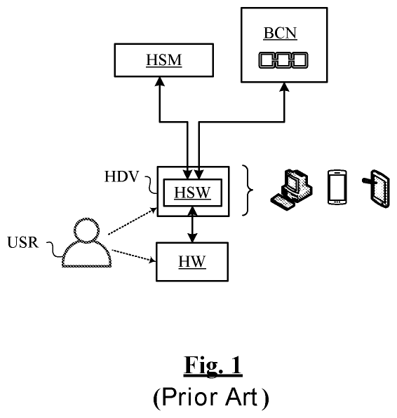

### DETAILED DESCRIPTION

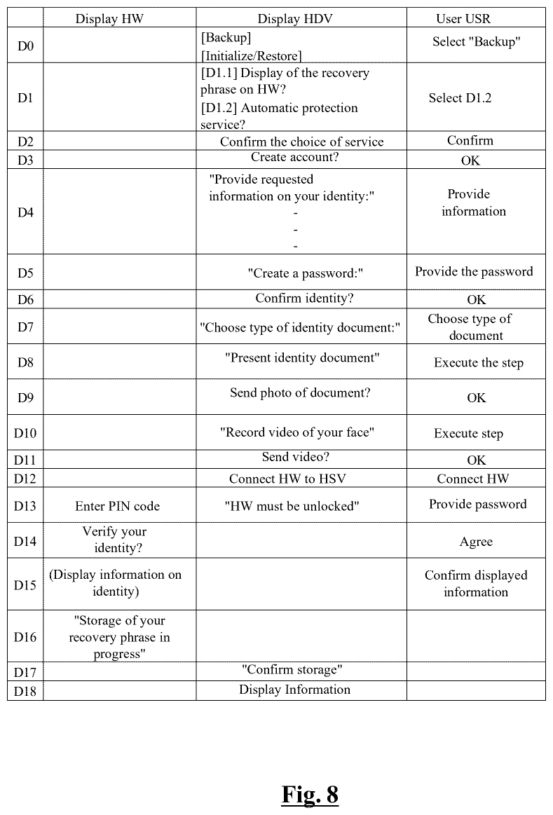

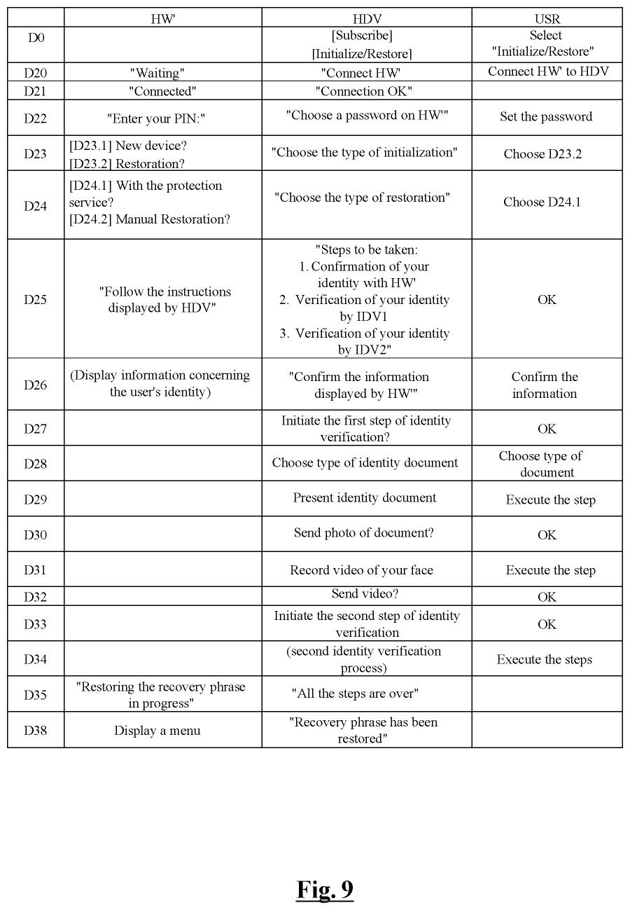

The disclosure provides a method allowing the creation of a cryptoasset wallet offering a unique functionality in the field of hardware wallets, namely a highly secure automated seed backup functionality. Such functionality allows users to free themselves from the difficulties and dangers attached to safekeeping a recovery phrase themselves in a safe place. The unique functionalities offered by a cryptoasset wallet according to the disclosure will be described later in relation to FIGS. 8, 9 and tables 2 and 3. Embodiments of the method according to the disclosure will first be described.

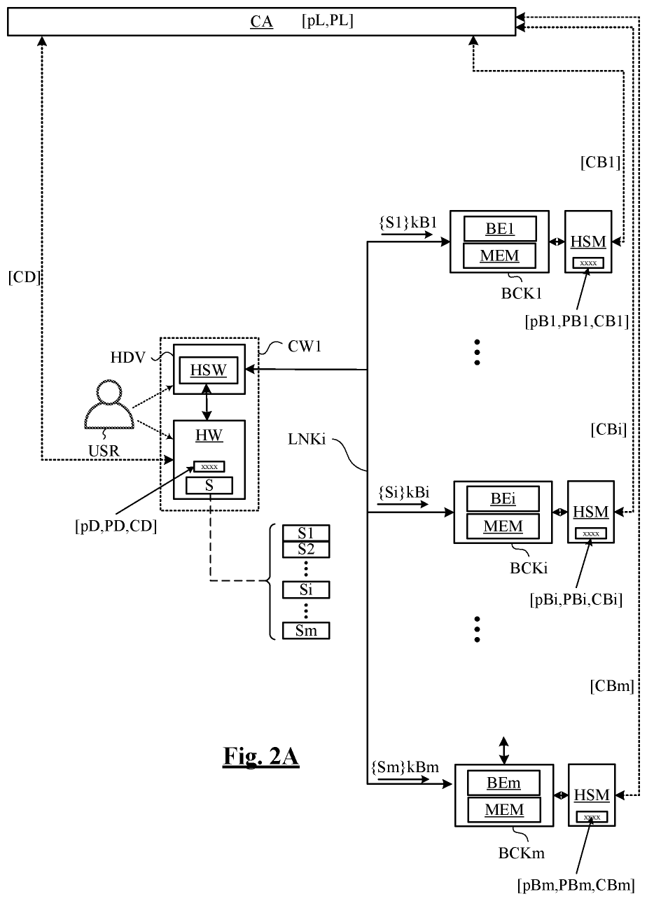

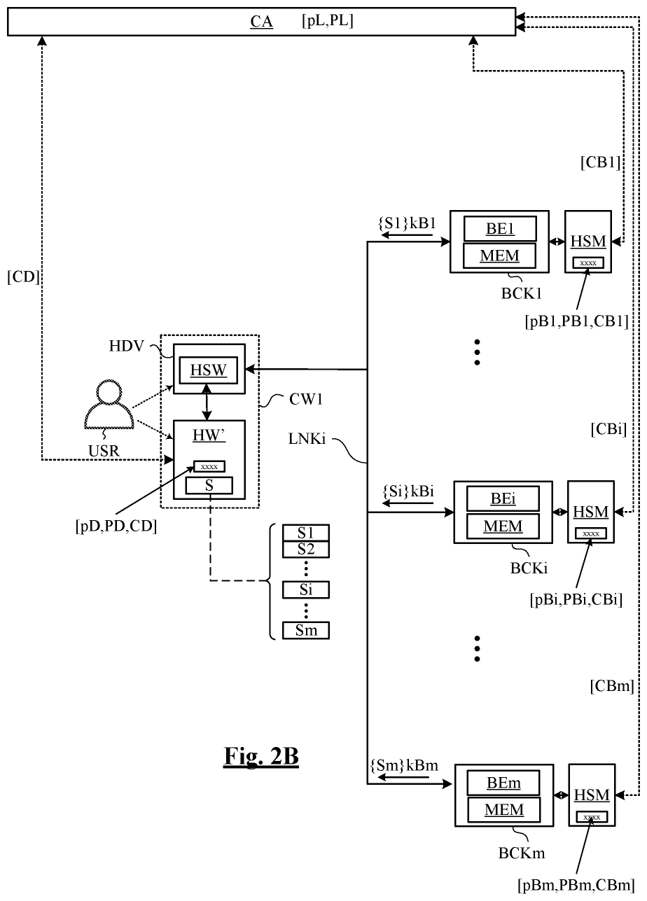

FIG. 2A shows a cryptoasset wallet CW1 and a system for implementing an embodiment of the method of the disclosure. The cryptoasset wallet CW1 here comprises a device HW and a host device HDV. The device HW is a hardware wallet ensuring the cold storage of a seed S or master key of a set of cryptoassets. The device HW has no means of connection to the Internet and is connected to the host device HDV, which executes companion software HSW allowing it to connect to the Internet, for example by means of a USB or Bluetooth connection. The system and the method according to the disclosure allow backing up or restoring the seed S (master key) stored in the device HW.

The system essentially comprises a set of m backup servers BCKi (BCK1, BCK2, . . . . BCKi, . . . . BCKm) each provided with a backup memory MEM (magnetic hard disk or solid state memory) for backing up shares Si of the seed S. Each backup server includes a backend program BEi (BE1, . . . . BEi, . . . . BEm), designed for implementing the method. Each backup server BCKi is also associated with a security module HSM.

According to the method of the disclosure, the device HW is configured to divide the seed S into a plurality of secret data Si (S1, S2 . . . . Si, . . . . Sm) which will be backed up on the servers BCKi. Rather than a simple splitting, which is nevertheless not excluded from the scope of the present disclosure, this “division” is preferably assured by means of a secret sharing function SS allowing the generation of a number m of secret data called “shares”, and allowing the reconstruction of the seed from a threshold of n secret data Si:

S1,S2, . . . ,Si, . . . ,Sm=SS(S)

For example, if m is equal to 3 and n is equal to 2, the SS function allows dividing the seed into three shares S1, S2, S3 but only two shares will be necessary to reconstruct the seed.

When the user wishes to back up their seed, the device HW establishes data connections LNKi (LNK1 to LNKm) with each backup server BCKi, through the host device HDV, for example through HTTPS. These data connections are then secured by the creation of secure channels of SCP type (“Secure Channel Protocol”) between the device HW and each backup server BCKi, in a manner that will be described.

The creation of such secure channels is ensured by means of a public key infrastructure managed by a certification authority CA. The device HW and the backup servers BCKi each possess a private key, a public key, a certificate signed by the certification authority, or static certificate, as well as the public key of the certification authority. The following notation will be used in what follows:
pL: private key of the certification authority
PL: public key of the certification authority
pD: private key of the device HW
PD: public key of the device HW
CD=[PD, Sign(pL, PD)]: certificate of the device (static certificate), comprising its public key PD and a signature of its public key by means of the private key pL of the certification authority
pBi: private key of a server BCKi (for i ranging from i to m)
PBi: public key of a server BCKi (for i ranging from i to m)

CBi=[PBi, Sign (pL, PBi)]: certificate of a server BCKi (static certificate), comprising its public key PD and a signature of its public key by means of the private key pL of the certification authority.

The signature function “Sign” is for example generated by means of an ECDSA signature algorithm based on elliptic curves (“Elliptic Curve Digital Signature Algorithm”).

The certification authority CA is preferably held by the manufacturer of the device HW, to allow it to control the allocation of certificates CBi to the backup servers BCKi. The backup servers BCKi can in turn be hosted by the manufacturer of the device HW, or be third-party partner servers participating in the implementation of the method. The keys pBi, PBi of the backup servers BCKi are held by their respective modules HSM, which handle the cryptographic calculations performed using these keys. In what follows and for the sake of language simplification, it will be considered that such cryptographic calculations are performed by the servers themselves.

To implement a secure communication channel, a key exchange is provided between the device HW and each backup server BCKi, allowing the generation of session keys kBi specific to each server BCKi but known to the device HW. This key exchange is for example a Diffie Hellman key exchange carried out according to the following steps:
i) each backup server BCKi generates a pair of ephemeral private key peBi and public key PeBi using an asymmetric key generator, then communicates its ephemeral public key PeBi to the device HW in an ephemeral certificate CeBi that it has signed with its private key pBi, as well as its certificate CBi signed by the trust authority:

CeBi=[PeBi,Sign(pBi,PeBi)]

CBi=[PBi,Sign(pL,PBi)]
ii) the device HW itself generates a pair of ephemeral private and public keys peD, PeD, then communicates its ephemeral public key PeD to the backup servers BCKi in an ephemeral certificate CeD that it has signed with its private key pD, as well as its certificate CD signed by the trust authority, i.e.:

CeD=[PeD,Sign(pD,PeD)]

CD=[PD,Sign(pL,PD)]
iii) each backup server BCKi verifies the signature of the ephemeral public key PeD of the device HW by means of the public key PD present in its certificate CD, then verifies the signature of the public key PD present in the certificate CD by means of the public key PL of the certification authority, or vice versa (verification of the signature of the public key PD before verification of the signature of the ephemeral public key PeD),
iv) similarly, the device HW verifies the signature of the ephemeral public key PeBi of each server BCKi by means of the public key PBi present in the certificate CB, then verifies the signature of the public key PBi present in the certificate CB by means of the public key PL of the certification authority, or vice versa,
v) each backup server BCKi generates an ephemeral session key kBi from its ephemeral private key peBi and the ephemeral public key PeD of the device HW, by means of a key exchange function such as, for example, the ECDH function (Elliptic Curve Diffie-Hellman key exchange), i.e.:

kBi=ECDH(peBi,PeD)
vi) the device HW generates the ephemeral session key kBi of each backup server BCKi from its ephemeral private key peD and the ephemeral public key PeBi of the backup server BCKi, by means of the same function, i.e.:

kBi=ECDH(peD,PeBi)

After generating the shares Si of the seed S, the device HW conducts symmetric encryption steps of each share Si with the session key kBi common to the backup server BCKi to whom the share Si is to be sent, which thus forms a shared key. In a simple implementation example, the device HW generates three shares S1, S2, S3 (the threshold n can then be equal to 2 or 3) and three backup servers BCK1, BCK2, BCK3 are provided. Each server BCKi generates its own session key kB1, kB2, kB3 and the device HW in turn generates each of these session keys after a key exchange with each server in the manner just described. Then, the device HW conducts symmetric encryption steps of the shares S1, S2, S3 by means of these keys, i.e.:
encrypts share S1 with key kB1, i.e. {S1}kB1, then sends it to server BCK1,
encrypts share S2 with key kB2, i.e. {S2}kB2, then sends it to server BCK2,
encrypts share S3 with key kB3, i.e. {S3}kB3, then sends it to server BCK3.

Each backup server BCKi then decrypts the encrypted share {Si}kBi that it has received from the device HW, and stores it in its memory MEM.

According to the method, and as illustrated in FIG. 2B, the restoration of seed S is carried out in a second hardware wallet denoted HW′. This can be a device other than the device HW if the latter has been lost, stolen, or destroyed. It can also be the device HW if it has been reset, the device HW then being considered as “another” device from the perspective of the method, since it no longer possesses the seed.

For the restoration of the seed, the secure channel creation steps described above are repeated. New session keys kBi are generated. Then, each server encrypts the share Si it holds with the session key kBi, i.e. {Si}kBi, then sends it to the device HW. The latter then decrypts each share Si by means of the corresponding session key kBi, then reconstructs the seed S by means of the inverse function of that which allowed generating the shares Si, denoted “SS⁻¹”:

S=SS⁻¹(S1,S2, . . . ,Si, . . . ,Sm)

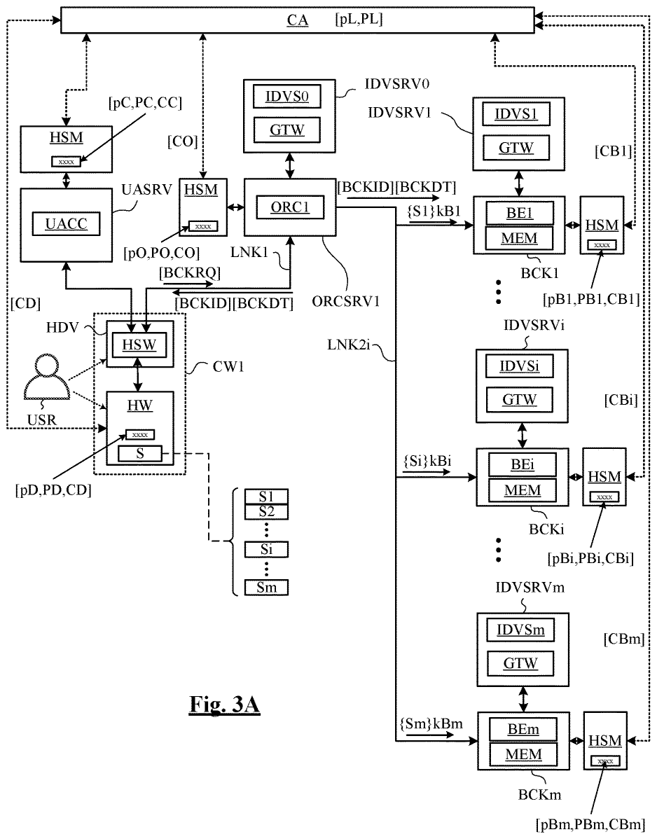

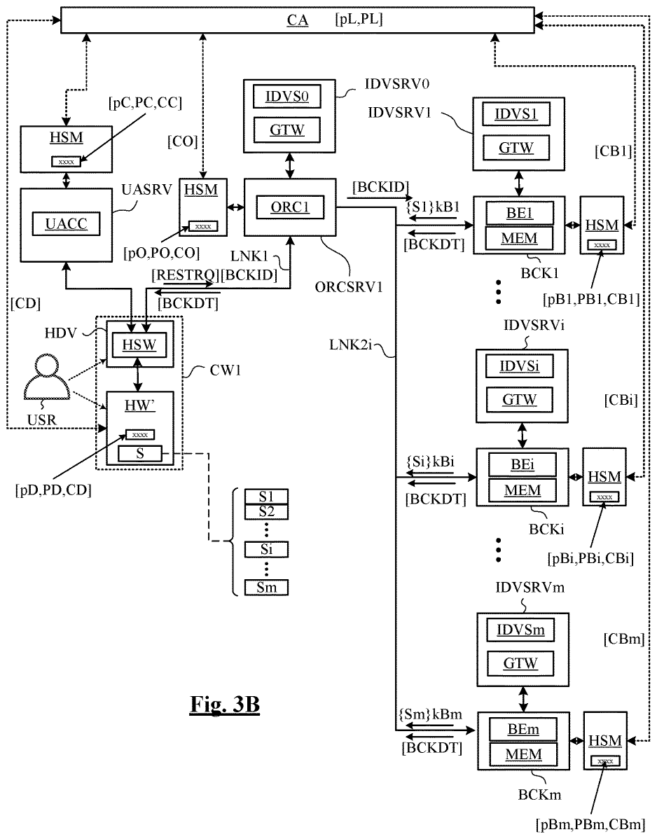

FIG. 3A shows the architecture of a system allowing the implementation of another embodiment of the method of the disclosure. In this embodiment, a server ORCSRV1 is interposed between the host device HDV and the backup servers BCKi. This server, called for illustrative purposes “orchestrator server”, executes a backend program ORC1 called in what follows “orchestrator program” or “orchestrator”. The server ORCSRV1 is connected to a security module HSM provided with a private key pO, a public key PO, and a certificate CO (static certificate) signed by the certification authority CA:

CO=[PO,Sign(pL,PO)]

For the implementation of the method, a first data connection LNK1 is established between the device HW and the orchestrator ORC1 by means of the host device HDV, for example an HTTPS connection. A plurality of data connections LNK2i are also established between the orchestrator and the backup servers BCKi, for example HTTPS connections, VPN IPsec, etc.

The data connection between the orchestrator and the device HW is secured by the creation of a secure channel according to the same technique as that described above:
i) the orchestrator ORC1 generates a pair of private and public keys PeO, PeO then communicates its ephemeral public key PeO to the device HW in an ephemeral certificate CeO that it has signed with its private key pO, accompanied by its certificate CO signed by the trust authority, i.e.:

CeO=[PeO,Sign(pO,PeO)]

CO=[PO,Sign(pL,PO)]
ii) the device HW generates a pair of ephemeral private and public keys peD, PeD, then communicates its ephemeral public key PeD to the orchestrator in an ephemeral certificate CeD that it has signed with its private key pD, accompanied by its certificate CD signed by the trust authority, i.e.:

CeD=[PeD,Sign(pD,PeD)]

CD=[PD,Sign(pL,PD)]
iii) the orchestrator ORC1 verifies the signature of the ephemeral public key PeD of the device HW by means of the public key PD present in the certificate CD, then verifies the signature of the public key PD by means of the public key PL of the certification authority, or vice versa,
iv) similarly, the device HW verifies the signature of the ephemeral public key PeO of the orchestrator by means of the public key PO present in the certificate CO, then verifies the signature of the public key PO by means of the public key PL of the certification authority, or vice versa,
v) the orchestrator ORC1 generates an ephemeral session key k0 from its ephemeral private key peO and the ephemeral public key PeD of the device HW:

k0=ECDH(peO,PeD)
vi) the device HW generates the ephemeral session key k0 from its ephemeral private key peD and the ephemeral public key PeO of the orchestrator:

k0=ECDH(peD,PeO)

Once the secure channel is created between the orchestrator and the device HW, data for the backup servers BCKi can be sent securely by the device HW to the orchestrator, thanks to symmetric encryption by means of the shared session key k0 of all or part of the exchanged data. Reciprocally, the orchestrator can communicate to the device HW in an encrypted form by means of the key k0 data received from the backup servers BCKi.

Secure channels are also created between the device HW and the backup servers BCKi by means of session keys kBi which are generated at the end of a key exchange through the data connection LNK1, the orchestrator acting as a gateway or “proxy server” between the device HW and the servers BCKi.

After execution of these steps, we distinguish:
through the data connection LNK1, a secure channel secured by the session key k0 shared by the orchestrator and the device HW, which allows encrypting the data exchanged between the orchestrator and the device HW,
through the data connections LNK2i, secure channels secured by the session keys kBi specific to each backup server BCKi and known to the device HW, which allows the device HW to exchange with each server BCKi data in encrypted form.

It can also be provided, in certain cases, to encrypt with the key k0 data that are received by the orchestrator in a form encrypted by the keys kBi, which corresponds to a superencryption of these data.

In an embodiment, the method of the disclosure implements two improvements concerning the transmission of the certificate CD of the device HW as part of a key exchange with any server. Indeed, the sending by the device of its certificate CD as part of such a key exchange constitutes a vulnerability in terms of confidentiality, the public key PD present in the certificate being exposed in case of line tapping. Furthermore, it has been demonstrated that an ECDSA signature allows retrieving the value of the corresponding public key. Thus, the transmission of the signature Sign (pD, PeD) of the ephemeral public key PeD in the ephemeral certificate CeD can also allow a third party to discover the public key PD.

These two improvements consist respectively in the encryption of the certificate CD and in the encryption of the signature Sign (pD, PeD). As an example, the implementation of these methods will be described in the context of the calculation of the session key k0 described above. The steps related to the key exchange previously described are modified as follows:
i) the orchestrator generates an ephemeral private key peO, an ephemeral public key PeO and an ephemeral certificate CeO signed with its private key pO, and transfers its ephemeral certificate CeO to the device as well as its certificate CO:

CeO=[PeO,Sign(pO,PeO)]

CO=[PO,Sign(pL,PO)]
ii) the device HW generates an ephemeral private key peD and an ephemeral public key PeD and calculates a first signature Sign (pD, PeD) of its ephemeral public key PeD from its private key pD and by means of the ECDSA algorithm,
iii) the device generates the session key k0 from its ephemeral private key peD and the ephemeral public key PeO of the orchestrator,
iv) the device encrypts its certificate CD with the session key k0:

{CD}k0
v) the device encrypts the first signature Sign (pD, PeD) by means of the session key k0:

{Sign(pD,PeD)}k0
vi) the device transfers to the orchestrator its certificate CD encrypted with the session key k0 as well as its ephemeral certificate CeD comprising the signature of its ephemeral public key PeD encrypted with the session key k0:

{CD}k0∥CeD

i.e.

{CD}k0∥PeD∥{Sign(pD,PeD)}k0

(∥ being the concatenation symbol)
vii) the orchestrator generates the session key k0 from its ephemeral private key peO and the ephemeral public key PeD received from the device, and
viii) by means of the session key k0, the orchestrator decrypts the signature present in the ephemeral certificate CeD and decrypts the certificate CD of the device.

It will be clear to the skilled person that these two methods of encrypting the certificate CD and encrypting the signature of the ephemeral public key PeD may be implemented separately, the public key may be encrypted without encrypting the signature or vice versa. It will also be apparent to the skilled person that these two methods are of universal application and may be implemented during the creation of any secure channel based on a key exchange and the generation of signatures with the ECDSA algorithm.

Returning to FIG. 3A, it follows from the above that the provision of the orchestrator ORC1 allows reducing the number of data connections between the device HW and the backup servers BCKi, these connections being replaced by the single data connection LNK1 between the device HW and the orchestrator, while ensuring an additional degree of security thanks to the possibility of superencrypting data transiting through the connection LNK1, as indicated above. Moreover, it is possible to preserve the confidentiality of the public key PD thanks to the improvements that have just been described. The provision of the orchestrator presents various other advantages that will be described later in relation to the implementation of user identity verification steps.

The step of backing up the seed S may in this case be implemented as follows, with reference to FIG. 3A:
i) establishing the connection LNK1 between the device HW and the orchestrator and sending by the device HW a backup request BCKRQ to the orchestrator,
ii) generating by the orchestrator a random identifier BCKID of the backup, establishing the connections LNK2i between the orchestrator and the backup servers BCKi, sending the identifier BCKID by the orchestrator to the backup servers BCKi,
iii) creating the secure channel between the device HW and the orchestrator ORC1 by means of the session key k0,
iv) creating secure channels between the device HW and the backup servers BCKi by means of the session keys kBi, through the orchestrator ORC1,
v) generating the shares Si of the seed by the device HW S:

S1,S2, . . . ,Si, . . . ,Sm=SS(S)
vi) encrypting by the device HW each share Si by means of the session key kBi of the backup server BCKi to which the share Si is intended,
vii) sending by the device HW all the encrypted shares {Si}kBi to the orchestrator:

{S1}kB1∥{S2}kB2∥ . . . ∥{Si}kBi∥ . . . ∥{Sm}kBm
viii) sending by the orchestrator to each backup server BCKi the encrypted share {Si}kBi that is intended for it,
ix) decrypting by each server BCKi the share Si that is communicated to it, and storing in its memory in association with the backup identifier BCKID.

Furthermore, the step of restoring the seed S in a new device HW′, illustrated in FIG. 3B, triggered at the request of the user USR, comprises the following steps:
i) establishing the connection LNK1 between the device HW and the orchestrator and sending by the device HW a restoration request RESTRQ to the orchestrator, accompanied by the backup identifier BCKID,
ii) establishing the connections LNKi between the orchestrator and the backup servers BCKi, and sending by the orchestrator to the backup servers BCKi the identifier BCKID, so that they are informed of the restoration to be performed,
iii) creating the secure channel between the device HW and the orchestrator ORC1 by means of a new session key k0,
iv) creating secure channels between the device HW and the backup servers BCKi by means of new session keys kBi, through the orchestrator ORC1,
v) reading by each backup server BCKi, in its memory, by means of the identifier BCKID, the share Si it holds, and encrypting it by means of the new session key kBi,
vi) transmitting to the orchestrator, by each backup server BCKi, the encrypted share {Si}kBi,
vii) collecting by the orchestrator all the encrypted shares {Si}kBi provided by the backup servers BCKi:

{S1}kB1,{S2}KB2, . . . ,{Si}kBi, . . . ,{Sm}kBm
viii) transmitting to the device HW each encrypted share {Si}kBi, one after the other or all together:

{S1}KB1∥{S2}kB2∥ . . . ∥{Si}kBi∥ . . . ∥{Sm}kBm
ix) decrypting, by the device HW, each share Si by means of the session key kBi of the corresponding backup server BCKi:

Si={Si}⁻¹kBi
x) reconstructing the seed by the device HW and storing it in its memory:

S=SS⁻¹(S1,S2, . . . ,Si, . . . ,Sm)

It will be noted that in an embodiment the orchestrator may collect only n shares necessary for the reconstruction of the seed, if n is less than m. In this case, the seed is reconstructed from the n recovered shares:

S=SS⁻¹(S1,S2, . . . ,Si, . . . ,Sn)

It has been assumed in the foregoing that the backup identifier BCKID was kept by the companion software HSW of the host device HDV despite the loss of the device HW used during the backup. In an embodiment overcoming the case where the user would have definitively uninstalled the companion software HSW, a customer account server UASRV may be provided, comprising a user account UACC in which various data concerning the user are kept, in particular the backup identifier BCKID. The server UASRV is associated with a security module HSM receiving a private key pC, a public key PC, a certificate CC signed by the certification authority, and the public key PL of the latter. In this case, the device HW′ establishes a data connection with the server UASRV thanks to a key exchange defining a session key for the creation of a secure channel, with reciprocal verification of the certificates. Once the secure channel is established, the companion software HSW connects to the customer account UACC to recover the identifier BCKID. In a variant, the identifier BCKID is stored on the server UASRV but is not communicated to the companion software. A secure connection is established between the server UASRV and the orchestrator ORC1. The orchestrator transfers the identifier BCKID to the server UASRV at the time of backup and reciprocally receives the identifier BCKID from the server UASRV when the user wants to restore their seed.

In an embodiment, the user's identity is also associated with the backup process, by defining a set of pieces of information forming a “pivot identity” allowing identification. The information forming the pivot identity includes, for example, the first name, last name, and date of birth of the user, and optionally other information such as their place of birth. This information is collected by the companion software and is communicated to the orchestrator, which assembles it to form a binary string that will be designated “backup data” BCKDT. The data BCKDT may contain other information such as the date and time of the backup, and a name given by the user to the backup (to allow them to later distinguish multiple backups, if they possess several hardware wallets).

At the initialization of the backup, as shown in FIG. 3A, the orchestrator communicates the data BCKDT to the backup servers BCKi which will associate them, as well as the identifier BCKID, with the backed up shares Si. For confidentiality reasons, it might be preferred, in certain embodiments, that the orchestrator does not store the data BCKDT once the backup is performed. The data BCKDT are in this case only stored by the servers BCKi, which communicate them to the user USR for confirmation by the latter of their identity at the time of restoration, as shown in FIG. 3B.

In an embodiment of the method, the pivot identity of the user is verified during at least one identity verification step designated “IDV” (Identity Verification) which is conducted before the restoration of the seed. In an embodiment, several identity verification steps IDVi are preferably provided before proceeding with the restoration of the seed, these steps being conducted by all or part of the backup servers BCKi prompted for the restitution of a share Si of the seed S.

In an embodiment shown in FIG. 3B, these identity verification steps are entrusted to specialized service providers instead of being carried out by the backup servers BCKi themselves. Such service providers possess servers IDVSRVi each executing an automated identity verification service IDVSi accessible via a gateway GTW. Each backup server BCKi may be assigned a different server IDVSRVi, and be configured to connect to the gateway GTW of the service IDVSi executed by this server. Preferably, such services IDVSi are not entirely automated, at least for a part of them, and include human intervention especially in case of doubt about a person's identity.

Thus, each backup server BCKi or at least a part of them, is configured to perform a step IDVi of verification of the user's pivot identity when it receives a request for restitution of a share of the seed. The server is then preferably configured to refuse to return the share if this verification is not conclusive.

In an embodiment, the seed backup step is also preceded by an initial step IDV0, conducted by the orchestrator or supervised by it, of verifying the user's pivot identity (i.e., at least their first name, last name, and date of birth). In this case, a server IDVSRV0 is also associated with the orchestrator ORC1, and the orchestrator is configured to connect to a gateway GTW of a service IDVS0 executed by this server for performing the step IDV0.

During the optional step IDV0 preceding the backup or each of the steps IDVi intervening before the restitution of the seed shares, the orchestrator directs the user USR to the appropriate service IDVS0 or IDVSi, via the appropriate GTW gateway. The user must perform certain actions requested by the screen of the host device HDV and the included camera (for example a mobile phone camera, a personal computer webcam, etc.). For example, the service IDVS0 or IDVSi asks the user to provide a valid identity document including a photo, to take a photo of the identity document with the camera and send it. The service IDVS0 or IDVSi then asks the user to take a photo (selfie) or video of their face and send it. The service IDVS0 or IDVSi then verifies the authenticity of the identity document from the photo or video of the face, and the identity document, once verified, allows verification of the data of the pivot identity with a degree of certainty which can, in certain embodiments, be represented by a score. The result of this verification, and optionally the score, is communicated to the orchestrator. In an embodiment, the steps IDV also include verifications against government databases.

Although the step IDV0 is not as critical as those performed by the servers BCKi at the time of restitution of the shares Si, it ensures that the user has not made an error in providing the information relating to their identity, which is incorporated into the data BCKDT. Moreover, the information collected by the orchestrator during this step, such as the photo of the identity document and the photo or video of the face, may optionally be communicated to the backup servers BCKi via a specific communication channel, since this information is not part of the backup data BCKDT.

In an embodiment, the orchestrator ORC1 may suspend the seed backup process if it considers that the initial verification of the user's identity is not conclusive or is given a score that is too low. Furthermore, in another embodiment or in addition, the orchestrator receives from the backup servers BCKi information on the success of the identity verification steps IDVi that they have conducted or that have been conducted by the service providers to which they are affiliated. If a determined number of servers BCKi have not successfully verified the user's identity and refuse to return the shares Si they hold, the orchestrator may be configured to suspend the restitution of the shares Si by the servers that have successfully verified the user's identity. The orchestrator may optionally decide to subject the user to an additional step of verification of their identity.

In a variant, or in addition, the orchestrator receives from each backup server BCKi having conducted an identity verification step, a certainty score regarding the user's identity. If the average of the scores is below a first threshold, and/or if one of the scores is below a second threshold, the orchestrator suspends the restoration process and optionally subjects the user to an additional step of verification of their identity.

In the ultimate case where the user would have closed their account on the account server UASRV, would have uninstalled the companion software by deleting the data it contained, and would have lost their hardware wallet HW and could therefore no longer retrieve the backup identifier BCKID, a solution can be provided to allow them to recover their seed. The user would then undergo a plurality of individual steps of verification of their identity with each server BCKi to recover each share Si of the seed. A procedure involving a ministerial officer, such as a notary, may also be provided. Each provider IDV will also be able to verify that their approach is legitimate by ensuring that there is no account attached to this user in the system's account server, and entrust more in-depth investigation procedures to natural persons, such as conducting a telephone interview with the user, conducting a video conference with the user, conducting a face-to-face interview with the user, validation of a school or employment career of the user, etc.

It will be clear to the skilled person that the method of the disclosure is susceptible to various other embodiments and variants. In particular, the backup data BCKID could, in an embodiment, include in a compressed form the data collected at the step IDV0 to verify the user's pivot identity, such as the photo or video of their face and a photo of an identity document. The automated steps of verification of the user's pivot identity as conducted by the services IDVSi executed by the servers IDVSRVi or by the backup servers BCKi themselves, may include at least two of the following steps: acquiring, through a camera, a photo of a non-expired identity document including a photo of the user; acquiring, through a camera, one or more photos of the user's face; acquiring, through a camera, a video recording showing the user's face in motion, with liveness detection to verify that the user is real; acquiring a proof of residence, such as a utility or telephone bill; acquiring a fingerprint of the user; acquiring a validation code received by the user in a phone message, by email or by mail; activating by the user a link received by the user in a phone message, by email or by mail; and acquiring a hologram present on a non-expired identity document.

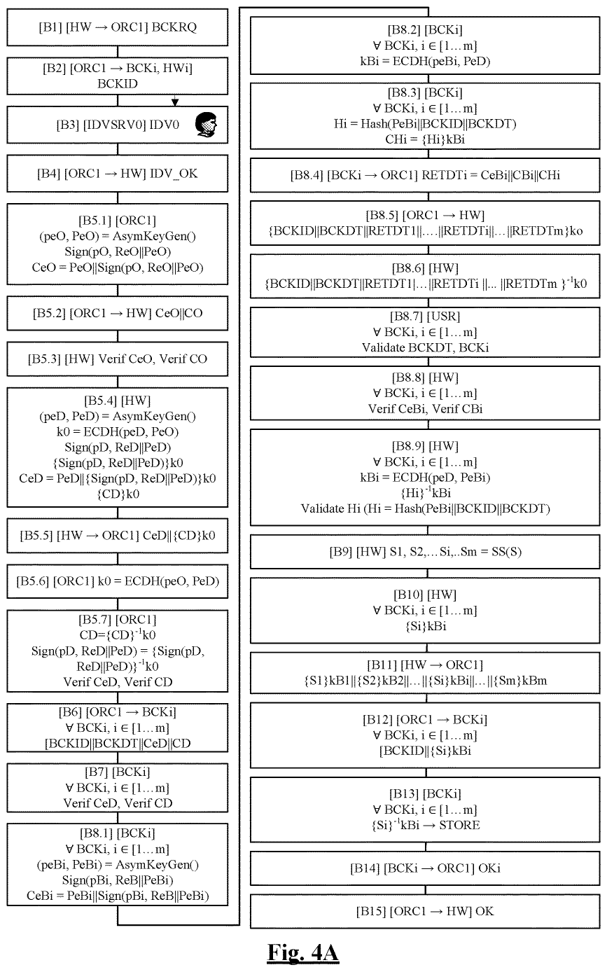

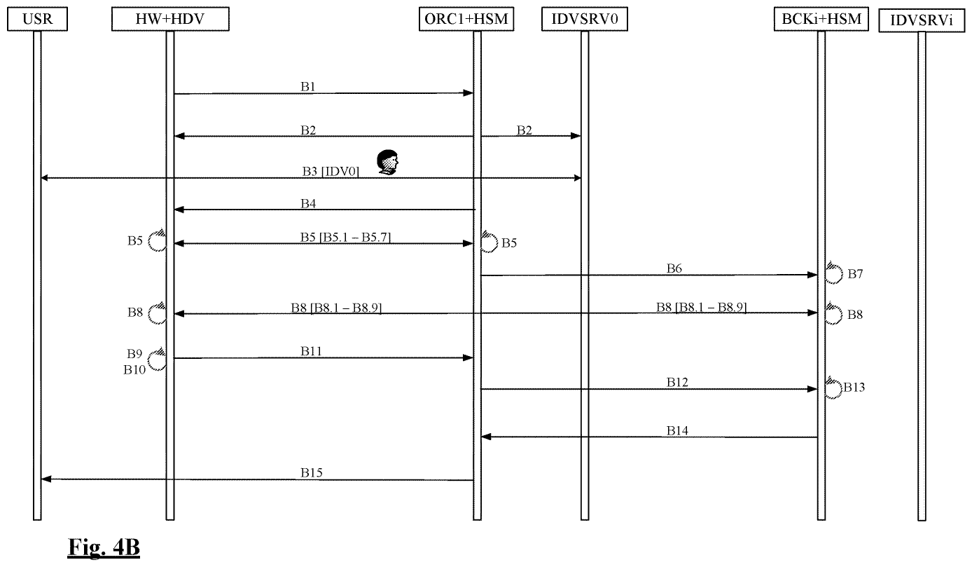

An example of a backup algorithm applicable to the system of FIG. 3A and implementing various aspects of the embodiments of the method previously described will now be described in relation to FIG. 4A. FIG. 4B is a sequence diagram that represents the steps of the algorithm in the form of interactions between:
the user USR,
the device HW and its host device HDV (considered as a single entity forming the cryptoasset wallet CW1),
the orchestrator ORC1 and its associated security module HSM (also considered as a single entity), and
the server IDVSRV0 associated with the orchestrator to perform the IDV0 step of verification of the user's identity,
the backup servers BCKi, and
the servers IDVSRVi associated with the servers BCKi to perform the subsequent identity verification steps, at the time of seed restoration.

Some functions used in the algorithm are indicated in table 1 below, as a non-limiting example:

TABLE 1

| Type of | |
|---|---|
| cryptography | Elliptic curve cryptography |
| Sign | ECDSA signature (Elliptic Curve Digital Signature Algorithm) with the |
| | secp256k1 elliptic curve |
| ECDH | Elliptic curve-based Diffie-Hellman key exchange using for example the |
| | secp256k1 elliptic curve |
| Hash function | SHA-256 (Secure Hash Algorithm) |
| Symmetric | AEAD-AES-SIV-CMAC-256 algorithm |
| encryption {.}k0 | |
| SS Function | Shamir Secret Sharing function or other similar function, or Pedersen |
| | PVSS (Publicly Verifiable Secret Sharing) based on the secp384r1 curve |

Description of the algorithm, in relation to FIGS. 4A and 4B.

### B1. Initialization of the Backup

The user USR selects a seed backup option in the device HW. The user, through the host device HDV, creates a backup account on the account server UASRV. The device HW establishes a data connection with the orchestrator ORC1 and sends it the backup request:

[HW→ORC1]

BCKRQ

Optionally the device HW offers the possibility to the user to choose the number m of shares Si that they wish to generate for backing up the seed, and the corresponding threshold n for the number of shares necessary for the reconstruction of the seed S. Still optionally, the device HW can present to the user a list of backup servers BCKi, some being potentially external partners, and ask the user to indicate those they wish to use. Otherwise, these are automatically selected by the orchestrator. The orchestrator ORC1 establishes a data connection with the servers BCKi, then engages the backup process according to the steps described in what follows.

### B2. Generating and Sending the Backup Identifier to the Device HW and to the Servers BCKi

[ORC1→BCKi,HW]BCKID

The orchestrator ORC1 generates the backup identifier BCKID, for example a random number, and transfers it to the device HW and to the servers BCKi.

### B3. Performing an Identity Verification IDV0 by the Server IDVSRV0

[IDVSRV0]IDV0

The orchestrator ORC1 connects the user to the server IDVSRV0 through a gateway GTW. The service IDVS0 proceeds with a verification of the user's pivot identity IDV0.

### B4. Confirming by the Orchestrator the Success of the Identity Verification

IDV_OK→HW

The server IDVSRV0 confirms to the orchestrator ORC1 that the IDV has been successfully performed, and the orchestrator ORC1 confirms to the user through the device HW that their identity has been verified and that the seed backup step can be initiated. On the occasion of this step, the orchestrator ORC1 may generate the backup data BCKDT, and send it to the device HW.

### B5. Mutual Authentication and Creation of a Secure Channel Between the Orchestrator and the Device

### B5.1 Generation by the Orchestrator of an Ephemeral Certificate

(peO,PeO)=AsymKeyGen( )

Sign(pO,ReO∥PeO)

CeO=PeO∥Sign(pO,ReO∥PeO)

The orchestrator ORC1 generates an ephemeral private key peO and an ephemeral public key PeO. The orchestrator calculates the signature of its ephemeral public key PeO by means of its private key pO. In a variant illustrated here, the orchestrator calculates the signature of its ephemeral public key PeO after having concatenated it with data ReO. The data ReO specifies for example the role that the orchestrator server plays in the method, for example the role of orchestrator for the establishment of a secure channel. The orchestrator then generates an ephemeral certificate CeO by concatenation of the ephemeral public key PeO and the signature.

### B5.2 Sending the Orchestrator's Certificates to the Device

CeO∥CO→HW

The orchestrator ORC1 sends to the device HW its ephemeral certificate and its certificate CO.

### B5.3. Verification by the Device of the Orchestrator's Certificates

Verif CeO,Verif CO

The device HW verifies the certificate chain of the orchestrator, in the manner described above, by means of the public key PL of the certification authority.

### B5.4. Generation by the Device HW of a Session Key k0 and an Ephemeral Certificate

(peD,PeD)=AsymKeyGen( )

k0=ECDH(peD,PeO)

Sign(pD,ReD∥PeD)

{Sign(pD,ReD∥PeD)}k0

CeD=PeD∥{Sign(pD,ReD∥PeD)}k0

{CD}k0

The device HW generates an ephemeral private key peD and an ephemeral public key PeD, then a session key k0 from its ephemeral private key peD and the ephemeral public key PeO of the orchestrator by means of the ECDH algorithm. The device HW then calculates the signature of its ephemeral public key PeD by means of its private key pD, here after having concatenated the ephemeral public key PeD with data ReD. The data ReD specifies for example the role that HW plays in the method. The device HW then encrypts the signature of its ephemeral public key with the session key k0, in accordance with the signature encryption process described above. The device HW then forms an ephemeral certificate CeD by concatenation of the ephemeral public key PeD and the encrypted signature. Finally, the device HW encrypts its certificate CD by means of the key k0, in accordance with the certificate encryption process described above.

### B5.5. Sending the Device's Certificates to the Orchestrator

[HW→ORC1]

CeD∥{CD}k0

The device HW sends to the orchestrator ORC1 its certificate CD encrypted by means of the key k0 as well as its ephemeral certificate CeD comprising the encrypted signature. Thanks to the encryption of the certificate and the encryption of the ephemeral certificate's signature, the public key PD is not exposed, as explained above. As indicated above, the order of these steps may be reversed, the device being able to send its certificate, here encrypted, before sending its ephemeral certificate, comprising here the encrypted signature.

### B5.6. Generation by the Orchestrator of the Session Key k0

k0=ECDH(peO,PeD)

The orchestrator ORC1 generates the session key k0 from its ephemeral private key peO and the ephemeral public key PeD of the device HW by means of the ECDH algorithm.

### B5.7. Verification by the Orchestrator of the Device's Certificates

CD={CD}⁻¹k0

Sign(pD,ReD∥PeD)={Sign(pD,ReD∥PeD)}⁻¹k0

Verif CeD,Verif CD

The orchestrator ORC1 decrypts the certificate CD of the device HW as well as the signature of the ephemeral certificate of the device HW, then verifies the certificate chain.

### B6. Sending to the Servers BCKi the Data BCKID, BCKDT and the Certificates CeD, CD of the Device

[ORC1→BCKi]
For each server BCKi, i ranging from 1 to m

BCKID∥BCKDT∥CeD∥CD

The orchestrator ORC1 sends to each server BCKi the backup identifier BCKID, the backup data BCKDT which includes at least the pivot identity data. As indicated above, other data may optionally be sent or have been sent to the backup servers by other channels, such as the photo or video of the user's face taken at the step IDV0, and the photo of an identity document. If these data are not included in the backup data BCKDT, they can be stored by the customer account server and transmitted to the servers BCKi after the backup.

### B7. Verification by Each Server BCKi of the Device's Certificates

For each server BCKi, i ranging from 1 to m

Verif CeD,Verif CD

Each server BCKi verifies the certificate chain of the device HW in the manner previously described.

### B8. Mutual Authentication and Creation of a Secure Channel Between the Servers BCKi and the Device, Through the Orchestrator

### B8.1 Generation by Each Server BCKi of an Ephemeral Certificate

For each server BCKi, i ranging from 1 to m

(peBi,PeBi)=AsymKeyGen( )

Sign(pBi,ReB∥PeBi)

CeBi=PeBi∥Sign(pBi,ReB∥PeBi)

Each server BCKi generates an ephemeral private key peBi and an ephemeral public key PeBi. Each server BCKi calculates the signature of its ephemeral public key PeBi after having concatenated it with data ReB by means of its private key pBi. ReB specifies for example the role that each server plays in the method, for example the role of backup server for the management of the secure channel. Then each server BCKi generates an ephemeral certificate CeBi by concatenation of the ephemeral public key PeBi and its signature.

### B8.2 Generation by Each Server BCKi of a Session Key kBi

For each server BCKi, i ranging from 1 to m
kBi=ECDH (peBi, PeD)

Each server BCKi then generates a session key kBi from its ephemeral private key peBi and the ephemeral public key PeD of the device HW, by means of the ECDH algorithm.

### B8.3 Generation by Each Server BCKi of an Encrypted Hash Code

For each server BCKi, i ranging from 1 to m

Hi=Hash(PeBi∥BCKID∥BCKDT)

CHi={Hi}kBi

Each server BCKi then generates a hash code Hi from a binary string comprising its ephemeral public key PeBi, the data BCKID and the backup data BCKDT. Each server BCKi then encrypts the code Hi by means of the session key kBi to obtain an encrypted hash code CHi.

### B8.4 Sending to the Orchestrator the Certificates of the Servers BCKi and the Encrypted Hash Code

[BCKi→ORC1]

RETDTi=CeBi∥CBi∥CHi

Each server BCKi sends to the orchestrator ORC1 a binary string RETDTi comprising its ephemeral certificate CeBi, its certificate CBi and the encrypted hash code CHi.

### B8.5 Sending to the Device the Certificates of the Servers BCKi and the Encrypted Hash Code

[ORC1→HW]

{BCKID∥BCKDT∥RETDT1∥ . . . ∥RETDTi∥ . . . ∥RETDTm}k0

The orchestrator ORC1 sends back to the device the data BCKID, BCKDT and all the data RETDTi received from the backup servers BCKi, in a form encrypted by means of the key k0. It will be noted here that the orchestrator does not have access to the RETDTi data because it does not know the private keys kBi of the servers BCKi. The data in the secure communication channel between the orchestrator and the device are therefore encrypted twice.

### B8.6 Decryption by the Device of the Certificates of the Servers BCKi and the Encrypted Hash Code

{BCKID∥BCKDT∥RETDT1∥ . . . ∥RETDTi∥ . . . ∥RETDTm}⁻¹k0

The device HW decrypts the data string to extract the data BCKID, BCKDT and the certificates CeBi, CBi, CHi.

### B8.7 Validation of the Data BCKDT and the Servers BCKi by the User

For each server BCKi, i ranging from 1 to m
Validate BCKDT, BCKi

The user as a natural person validates the backup data BCKDT and the servers BCKi in charge of the backup, which are presented to the user on the screen of the host device.

### B8.8 Verification by the Device of the Certificates of the Servers BCKi

For each server BCKi, i ranging from 1 to m
Verif CeBi, Verif CBi

The device HW verifies the certificate chain of each server BCKi.

### B8.9 Generation by the Device of the Session Keys kBi and Verification of the Encrypted Hash Codes

For each server BCKi, i ranging from 1 to m

kBi=ECDH(peD,PeBi)

{Hi}⁻¹kBi

Validate Hi

For each server BCKi, the device HW generates the session key kBi then decrypts the code Hi and validates it by recalculating the code Hi itself and comparing it to the decrypted code.

### B9. Preparation of the Backup, Generation of the m Shares Si

S1,S2, . . . Si, . . . Sm=SS(S)

By means of the secret sharing function SS, the device HW generates the m shares Si to be backed up in the different servers BCK1, BCK2 . . . . BCKm, with a threshold of n shares for recovering the seed S.

### B10. Encryption of the Shares Si by the Device

For each server BCKi, i ranging from 1 to m

{Si}kBi

For each server BCKi, the device HW encrypts the share Si that is intended for it with the key kBi that is specific to it.

### B11. Sending the Encrypted Shares Si to the Orchestrator

[HW→ORC1]{S1}

{S1}KB1∥{S2}kB2∥ . . . ∥{Si}kBi∥ . . . ∥{Sm}kBm→ORC1

The device HW then sends all the shares to the orchestrator ORC1. Note that the orchestrator lacks knowledge of the value of each share Si, as it is encrypted with the key kBi that it is unaware of.

### B12. Sending the Encrypted Si Shares to the Servers BCKi

[ORC1→BCKi]
For each server BCKi, i ranging from 1 to m

BCKID∥{Si}kB→BCKi

The orchestrator ORC1 transmits to each server BCKi the encrypted share Si that is designated for it, along with the backup identifier.

### B13. Decryption and Recording by Each Server BCKi of the Encrypted Share Si

For each server BCKi, i ranging from 1 to m

{Si}⁻¹kBi→STORE

Each server BCKi decrypts the share Si it has received and stores it in its memory MEM for backup.

### B14. Confirmation of the Backup to the Orchestrator by Each Server BCKi

[BCKi→ORC1]OKi

Each server BCKi acknowledges the orchestrator ORC1 by a message “OKi” (where i ranges from 1 to m) that it has successfully decrypted and stored the share of the seed entrusted to it. Optionally, each server BCKi can send an encrypted proof of the decryption of the share Si using a hash code signed with its session key. This signed hash code will be passed on to the device HW for verification.

### B15. Confirmation of the Backup to the User

[ORC1→HW]

OK

The orchestrator ORC1 sends a success message (“OK”) of the backup to the device HW, which displays a backup confirmation message on its screen for the attention of the user.

At the end of the process:
the device HW still holds the seed S,
the companion software HSW records the backup identifier BCKID,
the orchestrator ORC1 does not hold the seed S or the backup data BCKDT, and only holds the backup identifier BCKID,
each server BCKi holds the backup identifier BCKID, the backup data BCKDT which contain at least the user's pivot identity, and the share Si of the seed that has been entrusted to it.

The companion software HSW records the backup identifier BCKID and can also update the user's customer account UACC by recording therein the backup identifier BCKID.

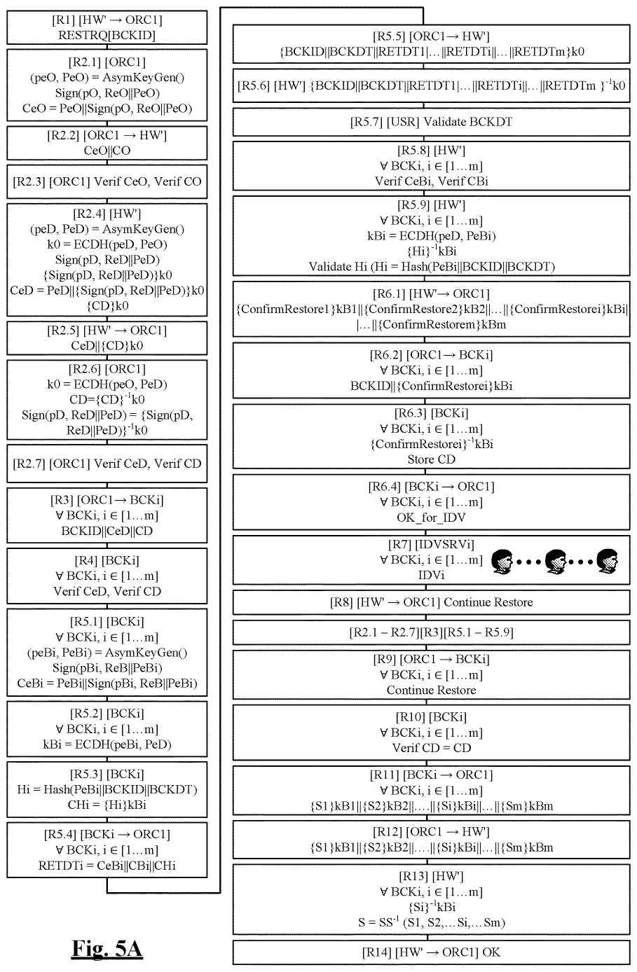

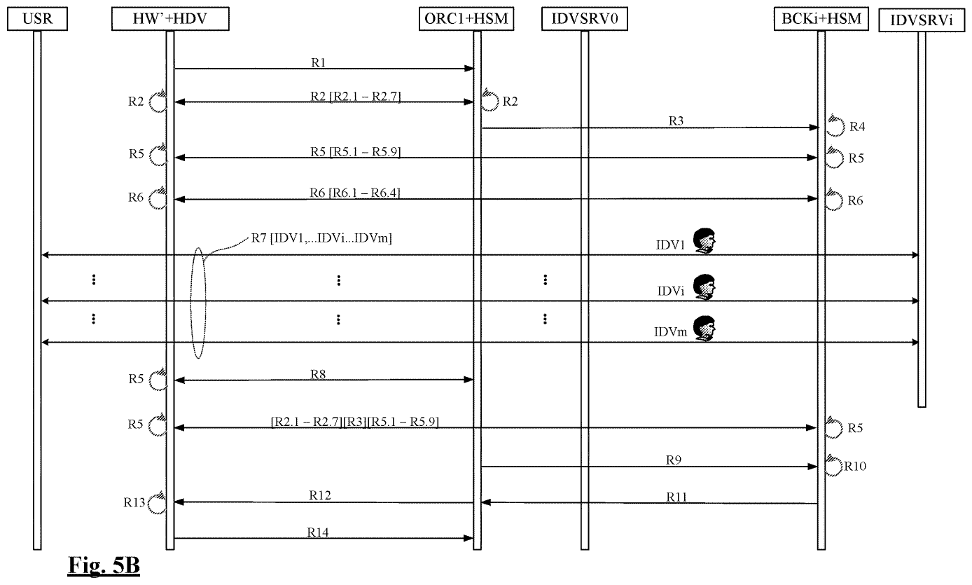

An example of a seed restoration algorithm applicable to the system of FIG. 3A and implementing various aspects of the embodiments of the method previously described will now be described in relation to FIG. 5A. FIG. 5B is a sequence diagram that represents the steps of the algorithm in the form of interactions between the entities previously mentioned.

It is considered here that the user has lost their device HW, or has irretrievably lost the password that allows its use. The user obtains a new device HW′ that they will use to recover the seed S, and connect it to the host device HDV whose companion software HSW has stored the backup identifier BCKID. The new device HW′ could also be the device HW that has been reset.

At the beginning of the process, the device HW′ holds a private key pD, a public key PD, a certificate CD certified by the certification authority, and the public key PL of the certification authority (the same designation as previously will be used for the keys and certificates of the device HW′). The restoration step includes the steps described below. Steps similar to those previously described will not be commented on again.

### r1. Sending by the Device a Restoration Request to the Orchestrator

HW′→ORC1

RESTRQ[BCKID]

The restoration is initiated by the device HW′ sending to the orchestrator a restoration request RESTRQ. The request contains the backup identifier BCKID. It is issued at the request of the user and selected through a menu displayed on the screen of the device HW″ or on the screen of the host device HDV.

R2. Mutual Authentication and Creation of a Secure Channel Between the orchestrator and the device

### R2.1 Generation by the Orchestrator of an Ephemeral Certificate

(peO,PeO)=AsymKeyGen( )

Sign(pO,ReO∥PeO)

CeO=PeO∥Sign(pO,ReO∥PeO)

### R2.2 Sending the Orchestrator's Certificates to the Device

ORC1→HW′

CeO∥CO

R2.3. Verification by the device of the orchestrator's certificates

Verif CeO,Verif CO

### R2.4. Generation by the Device of a Session Key and an Encrypted Ephemeral Certificate

(peD,PeD)=AsymKeyGen( )

k0=ECDH(peD,PeO)

Sign(pD,ReD∥PeD)

{Sign(pD,ReD∥PeD)}k0

CeD=PeD∥{Sign(pD,ReD∥PeD)}k0

{CD}k0

### R2.5. Sending the Certificates of Device HW′ to the Orchestrator

[HW′→ORC1]

CeD∥{CD}k0

### R2.6. Generation by the Orchestrator of the Session Key k0

k0=ECDH(peO,PeD)

CD={CD}⁻¹k0

Sign(pD,ReD∥PeD)={Sign(pD,ReD∥PeD)}−1k0

### R2.7. Verification by the Orchestrator of the Device's Certificates

Verif CeD,Verif CD

### R3. Sending to the Servers BCKi the Data BCKID and Certificates CeD, CD

[ORC1→BCKi]
For each server BCKi,i ranging from 1 to m

BCKID∥CeD∥CD→BCKi

The orchestrator ORC1 sends to each backup server BCKi the backup identifier BCKID, the ephemeral certificate CeD and the certificate CD of the device HW′.

### R4. Verification by Each Server BCKi of the Device's Certificates

For each server BCKi, i ranging from 1 to m

Verif CeD,Verif CD

R5. Mutual authentication and creation of a secure channel between the servers BCKi and the device, through the orchestrator

R5.1 Generation by each server BCKi of an ephemeral certificate
For each server BCKi,i ranging from 1 to m

(peBi,PeBi)=AsymKeyGen( )

Sign(pBi,ReB∥PeBi)

CeBi=PeBi∥Sign(pBi,ReB∥PeBi)

### R5.2 Generation by Each Server BCKi of a Session Key

For each server BCKi,i ranging from 1 to m

kBi=ECDH(peBi,PeD)

### R5.3 Generation by Each Server BCKi of an Encrypted Hash Code

Hi=Hash(PeBi∥BCKID∥BCKDT)

CHi={Hi}kBi

### R5.4 Sending to the Orchestrator by Each Server BCKi the Corresponding Certificate and Encrypted Hash Code

[BCKi→ORC1]
For each server BCKi,i ranging from 1 to m

RETDTi=CeBi∥CBi∥CHi

R5.5 Sending Data Received from the Servers BCKi to the Device

[ORC1→HW′]

{BCKID∥BCKDT∥RETDT1∥ . . . ∥RETDTi∥ . . . ∥RETDTm}k0

R5.6 Decryption by the Device of the Data String Received from the Orchestrator

{BCKID∥BCKDT∥RETDT1∥ . . . ∥RETDTi∥ . . . ∥RETDTm}⁻¹k0

### R5.7 Validation of the Backup Data by the User

Validate BCKDT

The user validates the backup data BCKDT, in particular first name, last name, date of birth, optionally place of birth.

### R5.8 Verification by the Device of the Certificates of the Servers BCKi

For each server BCKi, i ranging from 1 to m

Verif CeBi,Verif CBi

### R5.9 Generation by the Device of the Session Keys kBi and Verification of the Encrypted Hash Codes CHi

For each server BCKi,i ranging from 1 to m

kBi=ECDH(peD,PeBi)

{Hi}⁻¹kBi

Validate Hi(Hi=Hash(PeBi∥BCKID∥BCKDT)

### R6. Preparation of the Restoration

### R6.1 Sending by the Device Restoration Confirmations to the Orchestrator

[HW′=>ORC1]

{ConfirmRestore1}kB1∥{ConfirmRestore2}KB2∥ . . . ∥{ConfirmRestore_i}kBi∥ . . . |

{ConfirmRestore_m_}kBm→ORC1

The device HW′ sends back to the orchestrator ORC1 for each server BCKi, an individual restoration confirmation “ConfirmRestore_i_” which is encrypted with the key kBi of each server BCKi. Each confirmation is a predefined binary code.

R6.2 Sending the restoration confirmations to the servers BCKi
For each server BCKi,i ranging from 1 to m

BCKID∥{ConfirmRestore_i_}kBi→BCKi

The orchestrator ORC1 sends to each server BCKi the concatenated backup identifier BCKID and the restoration confirmation {ConfirmRestore_i_}kBi intended for it.

### R6.3 Verification by the Servers BCKi of the Restoration Confirmations

For each server BCKi,i ranging from 1 to m

{ConfirmRestore_i_}⁻¹kBi

Store CD

Each server BCKi decrypts the confirmation message issued by the device HW′ and communicated to it by the orchestrator ORC1, and memorizes the certificate CD of the device HW′ that it has previously verified.

R6.4 Confirmation by Each Server BCKi that the Restoration May be Initiated Subject to Identity Verification

[BCKi→ORC1]
For each server BCKi, i ranging from 1 to m

OK_for_IDV

Each server BCKi indicates to the orchestrator ORC1 that it is ready to return the share Si it has backed up subject to the user identifying themselves through a step IDVi.

### R7. Conducting the Identity Verification Steps IDVi by the Servers IDVSRVi

For each server BCKi, i ranging from 1 to m
IDVRi

The user is redirected by the orchestrator ORC1 to each server BCKi and each server BCKi proceeds with its own verification IDVi of the user's pivot identity. In the present embodiment where the steps IDVi are entrusted to service providers, each server BCKi connects the user to the server IDVSRVi to which it is affiliated through a gateway GTW. The service IDVSi of the provider proceeds with a verification of the user's identity, then confirms to the orchestrator ORC1 that their identity has been verified and that the seed backup step may be initiated.

It will be noted that the duration of each identity verification step IDVRi may range from a few minutes to several days depending on the requirements of each server BCKi or the provider performing the IDVRi. Verifications by natural persons may be systematically planned with certain IDV providers.

R8. Reestablishment of Secure Communication Channels after Completion of the Identity Verification Steps IDVi

[HW′→ORC1]

Continue Restore

Once the identity verification step is completed, sometimes several days later, the user restarts the restoration step. The device HW′ sends to the orchestrator ORC1 a request “Continue Restore” to resume the restoration.

Repetition of steps R2.1 to R2.7, R3, R5.1 to R5.9

As several days may elapse during the achievement of the IDVi verification steps, in an embodiment, the previous session certificates are not kept. Thus, steps R2.1 to R2.7, R3, R5.1 to R5.9 are executed again to resume the restoration process where it stopped, but with new session keys k0 and kBi.

### R9. Resumption of the Restoration

[ORC1→BCKi]
For each server BCKi, i ranging from 1 to m (or i ranging from 1 to n)

Continue Restore→BCKi

Once the secure channels are reopened by means of new session keys, the orchestrator passes on to the servers BCKi the request to continue the restoration. It will be noted that if during the steps IDVRi one of the servers BCKi cannot verify the user's identity with a determined degree of certainty, it will refuse to return the share it holds and will inform the orchestrator ORC1. If a determined number of backup servers BCKi have not successfully verified the user's identity and refuse to return the data they hold, the orchestrator may be configured to suspend the restitution of the shares by the servers that have successfully verified the user's identity. It may optionally decide to subject the user to an additional procedure for verification of their identity. The orchestrator may also be configured to analyze certainty scores regarding the verification of the user's identity, as indicated above, and take a decision based on this analysis.

Moreover, in a variant of the method mentioned above and as indicated in parentheses below, this step is limited to n backup servers BCKi, instead of all the backup servers, if only n shares are necessary for the reconstruction of the seed, n being smaller than m.

### R10. Verification of the Device's Certificate

For each server BCKi, i ranging from 1 to m (or i ranging from 1 to n)

Verif CD=CD

Each server BCKi ensures that the certificate CD of the device HW′ is the same as the certificate CD received and stored before conducting the identity verification steps IDVi.

### R11. Transfer of the Shares to the Orchestrator by the Servers BCKi

For each server BCKi, i ranging from 1 to m (or i ranging from 1 to n)

{S1}KB1∥{S2}kB2∥ . . . ∥{Si}kBi∥ . . . ∥{Sm}kBm→ORC1

Each server BCKi sends to the orchestrator ORC1 the share Si it holds, encrypted by means of the server's key kBi, which the orchestrator does not know.

### R12. Transfer of the Shares to the Device by the Orchestrator

{S1}kB1∥{S2}KB2∥ . . . ∥{Si}kBi∥ . . . ∥{Sm}kBm→HW′

The orchestrator ORC1 sends to the device HW′ all the shares Si received from the servers BCKi in encrypted form by means of the keys kBi.

### R13. Decryption of the Shares by the Device and Restoration of the Seed

For each server BCKi, i ranging from 1 to m (or i ranging from 1 to n)

{Si}⁻¹kBi

S=SS⁻¹(S1,S2, . . . Si . . . Sm)

(or S=SS⁻¹(S1,S2, . . . Si . . . Sn))

After decrypting each share of rank i by means of the corresponding key kBi, the device HW′ restores the seed from the received shares, or a part of them if their number is greater than n.

### R14. Final Confirmation

OK→ORC1

The device HW′ confirms to the orchestrator ORC1 that the seed restoration is complete.

It will be clear to the skilled person that the method that has been described is susceptible to numerous other variants and embodiments. The structure of the certificates involved in the method has been described above according to two variants, for example:

Cx=[Px,Sign(pL,Px)]

Cex=Pex∥{Sign(px,Rex∥Pex)

The ephemeral certificates could also be of the type:

Cex=Pex∥{Sign(px,Pex)

The method may also be implemented with any certificate structure. In particular, X509 certificates can be used. Similarly, other encryption functions or cryptographic algorithms can be used, particularly in the context of an implementation based on RSA cryptography.

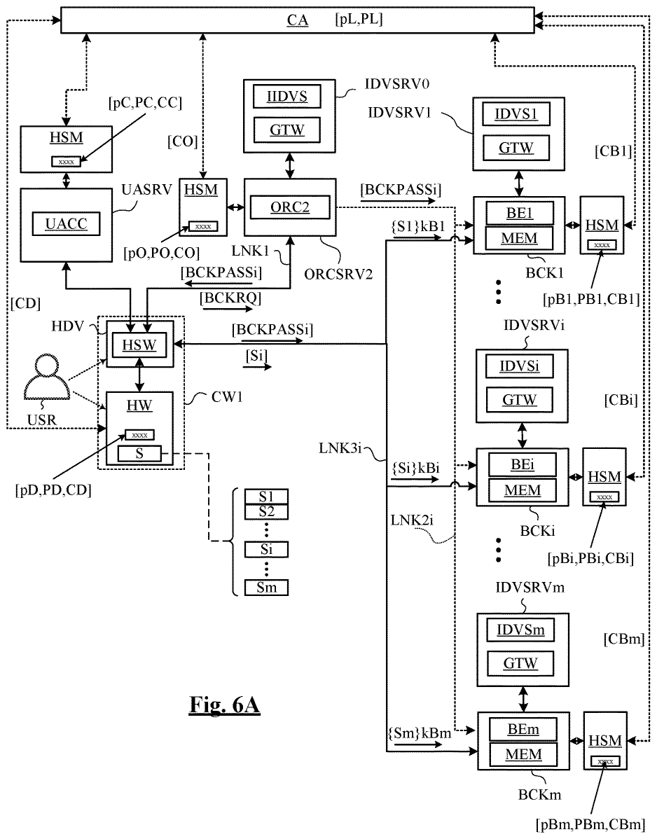

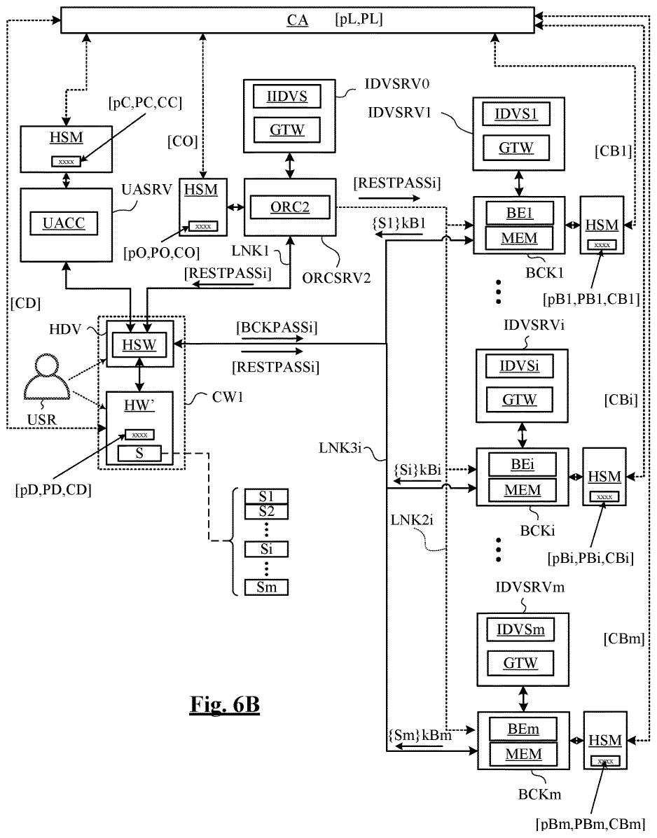

FIG. 6A shows a system for implementing the method of the disclosure which differs from that of FIG. 3A in that the server ORCSRV1 is replaced by a server ORCSRV2 that executes an orchestrator program ORC2 (hereinafter “orchestrator ORC2”). The orchestrator ORC2 differs from the orchestrator ORC1 in that it does not ensure the transmission to the device HW of the data issued by the backup servers BCKi, and reciprocally, and thus does not act as a gateway or “proxy server”.

When the user initiates a seed backup step, the device HW addresses a backup request BCKRQ to the orchestrator ORC2 following which the orchestrator ORC2 engages the previously described steps of generating a backup identifier BCKID, and of collecting information concerning the user, to generate the backup data BCKDT. The orchestrator also conducts the initial step IDV0 of verification of the user's pivot identity (i.e., at least their first name, last name, and date of birth). If this step is conclusive, the orchestrator delivers to the device HW backup authorizations BCKPASSi, one authorization per backup server BCKi, and sends each authorization to the concerned server BCKi.

Each authorization BCKPASSi forms a sort of “passport” allowing the device HW to know which server BCKi it should address to back up a share Si of the seed, and allowing it to connect to the server BCKi to proceed with the backup without being rejected by the server. Each authorization BCKPASSi may include various pieces of information, in particular the information that was previously in the backup data BCKDT and the identifier BCKID. The authorizations BCKPASSi are kept by the companion software as well as, preferably, in the user's account UACC on the account server UASRV. In a variant, the orchestrator delivers a general authorization BCKPASS containing a concatenation of all the information contained in the authorizations BCKPASSi.

With reference to FIG. 6B, when the user wishes to restore the seed, the companion software connects to the backup servers BCKi that it identifies by means of the addresses contained in the authorizations BCKPASSi, then reverts to the device HW for it to establish secure channels with the backup servers BCKi, by key exchanges as described above. When the secure channels have been created, the backup servers BCKi engage the steps IDVi of verification of the user's pivot identity.

The role of supervisor of the steps IDVi that was previously devolved to the orchestrator ORC1 may also be devolved here to the orchestrator ORC2. This orchestrator is then solicited by the backup servers BCKi to analyze the results of the steps IDVi. If these results are conclusive, the orchestrator ORC2 delivers to the device HW restoration authorizations RESTPASSi which it also communicates to the backup servers BCKi. The device HW then reestablishes a secure channel with the backup servers BCKi and presents them the authorizations RESTPASSi to recover the shares Si of the seed.

In the ultimate case where the user would have closed their account on the account server UASRV, uninstalled the companion software by deleting the data it contained, and could therefore no longer recover the authorizations BCKPASSi, as well as in the ultimate case where the orchestrator ORC2 would no longer exist, a solution is provided to allow the user to recover their seed, by allowing them to conduct a plurality of individual steps of verification of their identity with each backup server BCKi.

In a variant of the method facilitating the recovery of the shares in case of total failure of the system, or loss of the identifier BCKID (embodiment FIGS. 3A, 3B) or authorizations BCKPASSi, it can be provided that the organization in charge of the orchestrator ORC1 or ORC2 delivers to the user, for example by postal mail, a backup certificate bearing an inviolable authenticity certificate such as a hologram. Such a backup certificate will not spare the user the steps of verification of their identity with the backup servers, but will contain enough information to offer an additional degree of certainty as to their quality as legitimate holder of the seed when the verification steps IDVi are conducted.

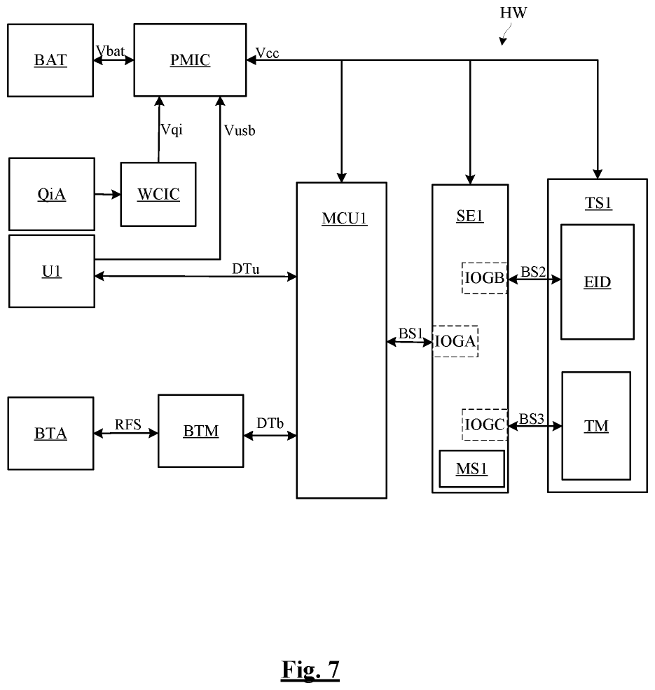

FIG. 7 shows an example of implementation of a hardware wallet HW allowing the implementation of the method. The device HW comprises a secure element SE1, a microcontroller MCU1 and a touchscreen TS1. The touchscreen TS1 comprises an electronic ink display EID and a touch module TM. The touchscreen TS1 is under the control of the secure element SE1. For this purpose, the resources in terms of inputs/outputs of the secure element SE1 are divided into three groups of inputs/outputs IOGA, IOGB, IOGC. The inputs/outputs group IOGA is assigned to the implementation of a bus BS1 connecting the secure element SE1 to the microcontroller MCU1. The inputs/outputs group IOGB is assigned to the implementation of a bus BS2 connecting the secure element SE1 to the display EID, and the inputs/outputs group IOGC is assigned to the implementation of a bus BS3 connecting the secure element SE1 to the touch module TM. The bus BS1 is for example an IEC/ISO 7816 bus, the bus BS2 is for example an SPI bus and the bus BS3 an I2C bus. The secure element is for example an STMicroelectronics® ST33K series chip. The device HW also includes various peripherals controlled by the microcontroller MCU1, for example:
a battery BAT;
an integrated circuit PMIC for power management receives a voltage Vbat from the battery when it is charged, provides the voltage Vbat to the battery when it needs to be charged, and provides a regulated supply voltage Vcc to the microcontroller MCU1, to the secure element SE1 and to the touchscreen TS1;
an antenna QiA for induction charging of the battery in accordance with Qi technology. The antenna QiA is connected to a wireless charging integrated circuit WCIC. The circuit WCIC provides a voltage Vqi to the circuit PMIC for charging the battery;
a USB port U1. The USB port provides to the circuit PMIC a voltage Vusb for charging the battery, provides to the microcontroller MCU1 data DTu received from an external device connected to the USB port, and transmits data DTu to the external device;
a Bluetooth antenna BTA, receiving a radio frequency signal RFS provided by a Bluetooth management circuit BTM. The circuit BTM provides data DTb exchanged with an external device via a Bluetooth connection or transmits data DTb to the external device via the Bluetooth connection.

The device HW features a touchscreen exclusively controlled by the secure element SE1 and therefore not susceptible to corruption, even in case of attack on the microcontroller MCU1. The microcontroller does not execute any application program and does not store any of the cryptographic secrets used by the secure element. It only manages the peripherals by transmitting to the secure element the data DTb, DTu received by the communication interface chosen by the user, or by transmitting to the external device data DTb, DTu provided by the secure element. The device HW therefore offers no possibility of direct connection to the Internet and remains, despite its touchscreen, a hardware wallet for cold storage of private keys offering the highest level of security. The secure element SE1 also includes a memory space MS1 comprising a read-only memory zone, a non-volatile electrically erasable programmable memory zone and a volatile memory zone. The non-volatile electrically erasable programmable memory zone receives an operating system of the secure element. It is configured to implement the method of the disclosure.

The device HW lends itself well to the implementation of the method thanks to its touchscreen, which can be chosen of large size and present for example a diagonal greater than or equal to 3.5 inches (one inch being equal to 2.54 cm), and include at least 600×400 pixels. In an embodiment, the screen has a diagonal of 3.9 inches (9.906 cm) and offers 670×496 pixels, which constitutes a very large screen for a hardware wallet of cryptoassets devoid of Internet connectivity.

Tables 2 and 3 below as well as FIGS. 8 and 9 describe an example of configuration of the device HW and the companion software HSW for the implementation of an embodiment of the method of the disclosure, in which three backup servers are used, the seed being therefore backed up by means of three shares. The device HW is used in association with the host device HDV to which it can be connected via its USB or Bluetooth interface. In addition to the touchscreen TS1 of the device HW, the host device HDV itself has a screen allowing the user USR to conduct with the companion software certain steps of the method while other steps are performed with the device HW.

In tables 2 and 3, the indications in brackets correspond to virtual buttons that the user must press to select the option they choose. The indications in quotation marks are information displayed by the device HW or the host device HDV. The indications “xx” correspond to displayed areas or areas in which the user provides the requested information.

Table 2 below and FIG. 8 describe the implementation of the method with regard to backing up the seed. During a step DO, the companion software offers the user the choice between (i) backing up the seed, and (ii) initializing or restoring the device HW. It is assumed here that the device HW has been previously commissioned but that the user has never backed up their seed. The user therefore chooses the first option. During a step D1, the companion software offers two options to the user, namely a conventional backup which will consist in the display of the recovery phrase by the device HW so that the user can save it on the support of their choice, or a backup by calling an automatic protection service implementing the method according to the disclosure. During a step D3, the user is invited to create an account on the customer account server. During a step D4, the user creates this account and provides information relating to their identity, of which at least a part constitutes the information of their pivot identity incorporated in the backup data BCKDT. During a step D5 they define the password of their account.

During a step D6 the companion software reminds the user that they will have to undergo an identity verification step. This is the step IDV0 that will allow the orchestrator to ensure that the information constituting their pivot identity is correct, in particular their first name, last name and date of birth. The step IDV0 is conducted at steps D7 to D11 using the screen of the host device HDV, as well as its camera. Once the step IDV0 is successfully completed, the user should connect the device HW to the host device HDV at a step D12.

Then, the device HW takes charge of the rest of the method by asking the user at a step D13 to enter their password, then at steps D14, D15 to verify their identity. The device HW then proceeds with backing up the seed at a step D16.

Table 3 below and FIG. 9 describe the seed restoration step. At step DO, the user chooses the Initialize/Restore option. During a step D20, the companion software asks the user to connect the device HW′ to the host device HDV. During a step D21, the companion software and the device HW′ confirm that the connection has been made. During a step D22, the user enters the password of the device HW′. During a step D22, the device HW′ proposes the user to specify if they want to initialize the device HW′ as a new device or if they want to proceed with a restoration from a recovery phrase. Here, the user chooses the “restoration” option. During a step D24, the device HW′ asks the user if they want to restore the device HW′ from the protection service according to the disclosure or from a recovery phrase that they would have kept (manual restoration). The user chooses the protection service.

During a step D25, the companion software takes charge of the rest of the method and informs the user that they will have to undergo three identity verification steps. The first will be carried out with the device HW′ and the other two will be carried out with IDV providers. During a step D26, the user should confirm the information displayed by the device HW′ concerning their pivot identity (additional information to that forming the pivot identity may be displayed by the device HW′ during this step, as seen in table 3). During a step D27, the companion software indicates to the user that they will be put in contact with the first IDV partner and asks them to confirm their agreement. The user's agreement leads the companion software to connect with a partner server IDVSRVi, through its gateway GTW, as described above. During steps D28 to D32, the user performs the actions requested by the first IDV partner for the acquisition of the information necessary for the first identity verification, using the screen and camera of the host device HDV. During a step D33, the companion software indicates to the user that they will be put in contact with the second IDV partner and asks them to confirm their agreement. The user's agreement leads the companion software to connect with another partner server IDVSRVi, through its gateway GTW. During steps summarized in the table by a single step D34, the user performs the actions requested by the second IDV partner for the acquisition of the information necessary for the second identity verification. These steps may be identical, similar or different from those of the first identity verification. It will be noted that the identity verification is not completed once these steps are carried out and that the result of each verification may be delayed a few hours or even a few days later, as explained above. When the user's identity has been verified, the device HW′ recovers the shares S1, S2, S3 of the seed and restores it during a step D35.

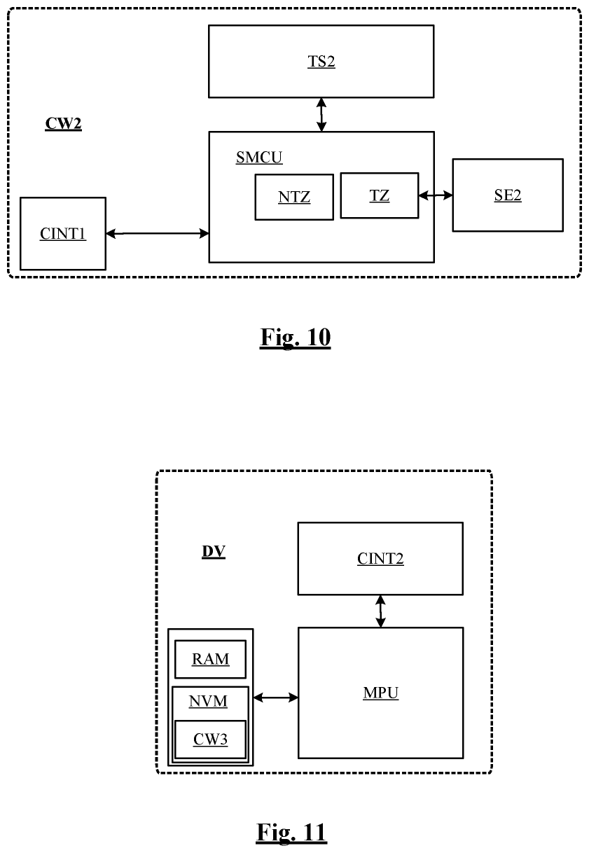

It will be clear to the skilled person that the method that has just been described may also be implemented with other types of cryptoasset wallets than the one that has just been described. The method may in particular be implemented with a cryptoasset wallet CW2 of the type shown in FIG. 10. The cryptoasset wallet CW2 comprises a secure microcontroller SMCU, a screen TS2 which may be a touchscreen, communication interface circuits CINT1 including notably Wi-Fi and/or Ethernet connectivity and allowing it to connect to the Internet. The secure microcontroller uses two virtual processors associated with hardware access control, allowing the management of two application execution zones TZ, NTZ offering different degrees of security, the TZ zone being called “trust zone”. The secure microcontroller may, in certain embodiments, be equipped with a secure element SE2 coupled to the trust zone TZ to perform cryptographic calculations and conduct the most sensitive operations in terms of security, notably storing the seed as well as various cryptoasset account keys. Each zone may function independently of the other while using the same kernel. In general, the microcontroller executes a so-called “rich” operating system in the less reliable zone NTZ, for example Android, and a specialized code in the trust zone TZ. Such a device is the equivalent of the combination of the hardware wallet HW (equivalent to the trust zone) and the host device HDV (equivalent to the less secure zone) described in the foregoing, and does not need to be connected to a host device to execute operations on the blockchain.

The method of the disclosure may also be implemented with a software-type cryptoasset wallet (“software wallet”). Unlike an online wallet, a software wallet allows storing cryptoasset keys directly on a desktop computer, laptop, mobile phone or equivalent. The user retains ownership of their keys and the seed, and should secure their storage themselves by ensuring that a fraudster cannot get hold of them. As an example, FIG. 11 shows a cryptoasset wallet CW3 of software type executed by an electronic device DV which may be of the aforementioned type, computer, mobile phone or equivalent. The device DV comprises a microprocessor MPU equipped with a communication interface CINT2 allowing it to connect to the Internet, volatile RAM memory and non-volatile memory NVM, for example a magnetic hard disk or a solid state hard disk (SSD). The program CW3 forming the software cryptoasset wallet is stored in the non-volatile memory NVM of the device DV and is executed by the microprocessor MPU using its RAM memory.

TABLE 2
Seed backup, interaction between the user, the hardware wallet HW and the host device HDV

| | Information displayed | | |
|---|---|---|---|
| | on touchscreen TS1 of | Information displayed by host | |
| | device HW | device HDV | User actions (USR) |
| D 0 | | [Backup] | User selects “Backup” |
| | | [Initialize/Restore] | |
| D 1 | | “Choose the type of protection for | User selects [Automatic |
| | | your recovery phrase”: | protection service for the |
| | | [D1.1] [Display of the recovery | recovery phrase] |
| | | phrase on your device and backup | |
| | | by yourself] | |
| | | [D1.2] [Automatic protection service | |
| | | for the recovery phrase] | |
| D 2 | | “After creation of your account and | Read the displayed |
| | | confirmation of your identity by one | information then confirm |
| | | of our IDV partners, your recovery | the choice of protection |
| | | phrase will be linked to your identity | service |
| | | in complete security. Your recovery | |
| | | phrase will be shared in three parts | |
| | | backed up in a decentralized | |
| | | manner, and cannot be stolen from | |
| | | you” | |
| | | [Confirm your choice of protection | |
| | | service] | |
| D 3 | | Please first create an account: | Agree to account creation |
| | | [Account creation] | |
| D 4 | | “Last name:” xx | Provide the requested |
| | | “First name:” xx | information, then validate |
| | | “Date of birth:” xx | |
| | | “Nationality:” xx | |
| | | “Place of birth:” xx | |
| | | [Validate] | |
| | | “Email address:” xx | |
| | | [Validate] | |
| | | “Verification code received by | |
| | | email:” xx | |
| | | [Validate] | |
| D 5 | | “Creation of a strong password” | Provide the password |
| | | “Enter your password:” xx | and validate it |
| | | “Confirm the password:” xx | |
| | | [Validate] | |
| D 6 | | “Your account has been | Agree to identity |
| | | successfully created. You will now | verification |
| | | confirm your identity with our | |
| | | partner” | |
| | | [I agree] | |
| D 7 | | “Choose the type of identity | Choose the type of |
| | | document” [Passport] [Driver's | document |
| | | license] [National identity card] | |
| | | [(Other choice)] | |
| D 8 | | “Present your identity document in | Execute the step |
| | | the frame” | |
| D 9 | | “Verify the photo and validate its | Verify photo and validate |
| | | sending” | sending |
| | | [Send the photo] | |
| D 10 | | “Place your face in the frame and | Execute the proposed |
| | | start the video” | step |
| | | [Start recording] | |
| D 11 | | “Verify the video then send it” | Verify video then validate |
| | | [Send the video] | sending |
| D 12 | | “Connect the device whose | Connects the device HW |
| | | recovery phrase you want to back | to the host device |
| | | up” | |
| D 13 | “Enter your PIN code:” xx | “Unlock your hardware wallet by | Provide password |
| | [Validate] | entering your personal password | |
| | | (PIN code)” | |
| D 14 | [Verify your identity before | | Agree to identity |
| | backing up your recovery | | confirmation |
| | phrase] | | |
| D 15 | “Last name, first name, | | Confirm the accuracy of |
| | date of birth, nationality, | | the displayed information |
| | place of birth” | | |
| | [Confirm] | | |
| D 16 | “Storage of your recovery | | Wait for the process to |
| | phrase in progress” | | complete |
| D 17 | “Your recovery phrase | “Account created: OK | |
| | stored securely” | Identity confirmation: OK | |
| | | Connection of your device: OK | |
| | | Backup of your recovery phrase: | |
| | | OK” | |
| D 18 | | “Your recovery phrase has been | |
| | | backed up. Restore it in another | |
| | | device whenever necessary” | |

TABLE 3
Seed restoration, interaction between the user and
the hardware wallet HW′ and the host device HDV

| | Information displayed | | |
|---|---|---|---|
| | on touchscreen TS1 of | Information displayed by host | |
| | device HW′ | device HDV | User actions (USR) |
| D 0 | | [Backup] | The user selects |
| | | [Initialize/Restore] | “Initialize/Restore” |
| D 20 | “Waiting” | “Connect the hardware wallet” | Connect their device to |
| | | | the host device |
| D 21 | “Connected” | “Connected to your hardware wallet” | |
| D 22 | “Enter your PIN:” xx | “Enter password (PIN) on your | Enter their password |
| | | device” | |
| D 23 | [D23.1] [New device] | “How do you want to initialize your | Choose the |
| | [D23.2] [Restoration with | device? New device or restoration | “Restoration” option |
| | a recovery phrase] | with a recovery phrase? Make your | |
| | | choice on the screen of your device” | |
| D 24 | [D24.1][Restoration with | “How do you want to restore your | Choose restoration with |
| | protection service] | device? Make your choice on your | the protection service |
| | [D24.2][Manual | device” | |
| | restoration with a | | |
| | recovery phrase] | | |
| D 25 | | “We propose the following steps: | Agree to the proposed |
| | | 1. Confirmation of your identity with | identity verification |
| | | your device | process |
| | | 2. Verification of your identity by a first | |
| | | IDV partner | |
| | | 3. Verification of your identity by a | |
| | | second IDV partner” | |
| | | [I agree] | |
| D 26 | (HW′ displays the | “1. Confirm your identity as displayed | Confirm the information |
| | information concerning | on your device” | displayed by the device |
| | the user's identity) | | HW′ |
| | “Last name:” xx | | |
| | “First name:” xx | | |
| | “Date of birth:” xx | | |
| | “Nationality:” xx | | |
| | “Place of birth:” xx | | |
| | “Email address: xx” | | |
| | [Validate] | | |
| D 27 | | “2. Verification of your identity by our | Agree |
| | | first IDV partner” | |
| | | [Confirm] | |
| D 28 | | “Choose the type of document” | Choose the type of |
| | | [Passport] [Driver's license] [National | document |
| | | identity card] [(Other choice)] | |
| D 29 | | “Present your identity document in the | Execute the proposed |
| | | frame” | step |
| D 30 | | “Verify the photo and validate its | Verify photo and |
| | | sending” | validate sending |
| | | [Send the photo] | |
| D 31 | | “Place your face in the frame and | Execute the proposed |
| | | start the video” | step |
| | | [Start recording] | |
| D 32 | | “Verify the video then send it” | Verify video then |
| | | [Send the video] | validate sending |
| D 33 | | “2. Verification of your identity by our | Agree |
| | | second IDV partner” | |
| | | [Confirm] | |
| D 34 | | (conducting the second identity | Executes the steps |
| | | verification process identical, similar | |
| | | or different from the first) | |
| D 35 | “Restoration of your | “1. Confirmation of your identity with | |
| | recovery phrase in | your device: OK | |
| | progress” | 2. Confirmation of your identity by our | |
| | | first IDV partner: OK | |
| | | 3. Confirmation of your identity by our | |
| | | second IDV partner: OK” | |
| D 36 | Displays a menu | “Your recovery phrase has been | |
| | | restored” | |

1. A method for backing up and restoring a secret held by a cryptoasset wallet comprising a hardware wallet for cold storage of the secret, the method comprising, for backing up the secret, the steps of:
providing an orchestrator program executed by a server,
providing a plurality of backup servers,
collecting information relating to an identity of a user of the cryptoasset wallet,
establishing a first secure communication channel between the cryptoasset wallet and the orchestrator program, the first secure communication channel being encrypted by means of a first session key generated by a first key exchange between the cryptoasset wallet and the orchestrator program,
establishing a second secure communication channel between the cryptoasset wallet and each backup server, through the first secure communication channel and the orchestrator program, the second secure communication channel being encrypted by means of a second session key generated by a second key exchange between the cryptoasset wallet and a corresponding backup server, the second session key being known only by the cryptoasset wallet and the corresponding backup server,
by means of the cryptoasset wallet, generating a plurality of secret data from the secret, each secret data being intended to be communicated to a backup server, encrypting each secret data by means of the second session key of the secure communication channel established with the backup server to which the data is intended, and transferring each data in its encrypted form to the orchestrator program through the first secure communication channel,
by means of the orchestrator program, communicating to each backup server the information relating to the user's identity, and transferring to each backup server one of the secret data in its encrypted form by means of the second session key of the secure communication channel established by the cryptoasset wallet with the concerned corresponding backup server, and
in each backup server, backing up the secret data by associating it with the user's identity.

2. The method according to claim 1, wherein the information relating to the user's identity includes at least the user's first name, last name, and date of birth.

3. The method according to claim 1, wherein the cryptoasset wallet is configured to generate a plurality of secret data by means of a secret sharing function designed to generate a number m of secret data from the secret and allow reconstruction of the secret from a threshold of n secret data.

4. The method according to claim 1, wherein the hardware wallet is devoid of means of connection to the Internet, and the cryptoasset wallet comprises a host device executing companion software and provided with an Internet connection, the hardware wallet being connected or configured to be connected to the host device.

5. The method according to claim 1, comprising, for the restoration of the secret, the following steps:
communicating to each backup server the information relating to the user's identity,
receiving by the cryptoasset wallet, in an encrypted form, all or part of the secret data held by the backup servers, and
reconstructing the secret by the cryptoasset wallet from the secret data provided by the backup servers and after decryption thereof.

6. The method according to claim 1, wherein the orchestrator program, and the cryptoasset wallet each possess a private key, a public key, a certificate signed by a certification authority, and a public key provided by the certification authority and wherein:
the orchestrator program transfers its certificate to the cryptoasset wallet,
the cryptoasset wallet transfers its certificate to the orchestrator program,
the orchestrator program generates an ephemeral private key, an ephemeral public key and an ephemeral certificate signed with its private key, and transfers its ephemeral certificate to the cryptoasset wallet,
the cryptoasset wallet generates an ephemeral private key, an ephemeral public key and an ephemeral certificate signed with its private key, and transfers its ephemeral certificate to the orchestrator program,
the cryptoasset wallet generates the first session key from its ephemeral private key and the ephemeral public key of the orchestrator program, and
the orchestrator program generates the first session key from its ephemeral private key and the ephemeral public key of the cryptoasset wallet.

7. The method according to claim 6, wherein, before transferring its ephemeral certificate to the orchestrator program:
the cryptoasset wallet generates a first signature of its ephemeral public key from its private key,
the cryptoasset wallet encrypts the first signature by means of the first session key, to obtain an encrypted signature,
the cryptoasset wallet transfers to the orchestrator program an ephemeral certificate comprising its ephemeral public key and the encrypted signature, then:
the orchestrator program generates the first session key from its ephemeral private key and the ephemeral public key of the cryptoasset wallet, and
by means of the first session key, the orchestrator program decrypts the signature present in the ephemeral certificate.

8. The method according to claim 7, wherein, before generating the first signature of its ephemeral public key from its private key, the hardware wallet concatenates its ephemeral public key with data.

9. The method according to claim 7, comprising the following steps:
the cryptoasset wallet encrypts its certificate with the first session key before transferring it to the orchestrator program, and
by means of the first session key, the orchestrator program decrypts the certificate of the cryptoasset wallet.

10. The method according to claim 6, wherein the backup servers each possess a private key, a public key, a certificate signed by a certification authority, and a public key provided by the certification authority,
the orchestrator program transfers the certificate of the cryptoasset wallet and the ephemeral certificate of the cryptoasset wallet to each of the backup servers,
each backup server transfers its certificate to the orchestrator program, which transfers it to the cryptoasset wallet,
each backup server generates an ephemeral private key, an ephemeral public key and an ephemeral certificate signed with its private key, and transfers the ephemeral certificate to the orchestrator program which transfers it to the cryptoasset wallet,
each backup server generates the second session key from its ephemeral private key and the ephemeral public key of the cryptoasset wallet, and
the cryptoasset wallet generates the second session key of each backup server from its ephemeral private key and the ephemeral public key of the backup server.

11. The method according to claim 10, wherein:
the cryptoasset wallet verifies the validity of the certificate of the orchestrator program by means of the public key of the certification authority,
the cryptoasset wallet verifies the validity of the ephemeral certificate of the orchestrator program by means of the public key of the certificate of the orchestrator program,
the cryptoasset wallet verifies the validity of the certificate of each backup server by means of the public key of the certification authority,
the cryptoasset wallet verifies the validity of the ephemeral certificate of each backup server by means of the public key of the certificate of each backup server,
the orchestrator program verifies the validity of the certificate of the cryptoasset wallet by means of the public key of the certification authority,
the orchestrator program verifies the validity of the ephemeral certificate of the cryptoasset wallet by means of the public key of the certificate of the cryptoasset wallet,
each backup server verifies the validity of the certificate of the cryptoasset wallet by means of the public key of the certification authority, and
each backup server verifies the validity of the ephemeral certificate of the cryptoasset wallet by means of the public key of the certificate of the cryptoasset wallet.

12. The method according to claim 10, wherein data transmitted to the orchestrator program by a backup server are retransmitted by the orchestrator program to the cryptoasset wallet in a form encrypted by means of the first session key, and wherein some of these data are previously hashed by the backup server by means of a hash function, then encrypted by means of the second session key of the secure communication channel it has established with the cryptoasset wallet.

13. The method according to claim 1, wherein before providing the secret data it holds, at least one backup server subjects the user to an identity verification step, and refuses to return the secret data if the verification of the user's identity is not conclusive.

14. A cryptoasset wallet comprising a hardware wallet for cold storage of a secret, the cryptoasset wallet configured to offer a user the following options:
manually back up the secret in the form of a recovery phrase for keeping by the user, or
back up the secret in a plurality of backup servers, and,
if the user chooses to back up the secret in a plurality of backup servers:
establish a first secure communication channel with an orchestrator program, the first secure communication channel being encrypted by means of a first session key generated by a first key exchange between the cryptoasset wallet and the orchestrator program,
collect information relating to the user's identity, in the presence of the user,
establish a second secure communication channel with each backup server, through the first secure communication channel and the orchestrator program, the second secure communication channel being encrypted by means of a second session key generated by a second key exchange between the cryptoasset wallet and a corresponding backup server, the second session key being known only by the cryptoasset wallet and the corresponding backup server,
generate a plurality of secret data from the secret, each secret data being intended to be communicated to a backup server, encrypt each secret data by means of the second session key of the secure communication channel established with the backup server to which the data is intended, and transfer each data to the orchestrator program in its encrypted form through the first secure communication channel, so that the orchestrator program transfers it to a backup server in its encrypted form.

15. The cryptoasset wallet according to claim 14, configured to also offer the user the following options:
manually restore the secret from a recovery phrase, or
restore the secret from a plurality of backup servers, and,
if the user chooses to restore the secret from a plurality of secret data held by a plurality of backup servers, reconstruct the secret from the data provided by the backup servers.

16. The cryptoasset wallet according to claim 14, configured to generate a plurality of secret data from the secret by means of a secret sharing function designed to generate a number m of secret data and allow reconstruction of the secret from a threshold of n secret data.

17. The cryptoasset wallet according to claim 14, configured to:
transfer the secret data to the plurality of backup servers through an orchestrator program executed by a server, and
recover each of the data provided by the backup servers through the orchestrator program.

18. The cryptoasset wallet according to claim 15, configured to, if the user chooses to restore the secret from the secret data, conduct at least one step of verification of the user's identity at the request of a backup server.

19. The cryptoasset wallet according to claim 14, wherein the hardware wallet is devoid of means of connection to the Internet, the cryptoasset wallet comprising a host device executing companion software and provided with an Internet connection, the companion software complementing the hardware wallet for the realization of steps requiring interaction with the user, in particular steps of collecting information relating to the user's identity.

20. The cryptoasset wallet according to claim 19, wherein the hardware wallet comprises a touchscreen with a diagonal greater than or equal to 3.5 inches and exclusively controlled by a secure element, used in particular to collect information relating to the user's identity.

21.-24. (canceled)
